(19) United States
(12) Patent Application Publication
(10) Pub. No.: US 2024/0406909 A1
(43) Pub. Date: Dec. 5, 2024

(54) Network Node, User Equipment and Methods in a Wireless Communications Network

(71) Applicant: Telefonaktiebolaget LM Ericsson (publ), Stockholm (SE)

(72) Inventors: Ritesh Shreevastav, Upplands Väsby (SE); Fredrik Gunnarsson, Linköping (SE); Pradeepa Ramachandra, Linköping (SE)

(21) Appl. No.: 18/261,501

(22) PCT Filed: Dec. 20, 2021
(86) PCT No.: PCT/EP2021/086722

§ 371 Date: Jul. 14, 2023

Related U.S. Application Data
(60) Provisional application No. 63/137,175, filed on Jan. 14, 2021.

(51) Int. Cl. H04W 64/00

(52) U.S. Cl. CPC H04W 64/00

(57) ABSTRACT

A method performed by a network node for handling positioning of a User Equipment (UE) in a wireless communications network is provided. The network node recommends (601) configurations for multiple Transmission Reception Points (TRPs), to transmit positioning signals. The network node further recommends (602) a configuration for the UE to perform positioning measurement of the positioning signals transmitted by the multiple TRPs. The network node obtains (604) a position of the UE based on positioning measurement results of the multiple TRPs. The network node obtains (605) errors based on uncertainty associated with the positioning measurement results of the multiple TRPs. The network node obtains (606) a Geometric Dilution of Precision (GDOP) for the multiple TRPs based on the obtained errors and the position of the UE. The network node then manages (607) transmission of the positioning signals of the multiple TRPs, based on the obtained GDOP.

### TECHNICAL FIELD

Embodiments herein relate to a network node, a User Equipment (UE) and methods therein. In some aspects, they relate to handling positioning of the UE in a wireless communications network.

### BACKGROUND

In a typical wireless communication network, wireless devices, also known as wireless communication devices, mobile stations, stations (STA) and/or User Equipment (UE), communicate via a Local Area Network such as a Wi-Fi network or a Radio Access Network (RAN) to one or more core networks (CN). The RAN covers a geographical area which is divided into service areas or cell areas, which may also be referred to as a beam or a beam group, with each service area or cell area being served by a radio network node such as a radio access node e.g., a Wi-Fi access point or a radio base station (RBS), which in some networks may also be denoted, for example, a NodeB, eNodeB (eNB), or gNB as denoted in 5G. A service area or cell area is a geographical area where radio coverage is provided by the radio network node. The radio network node communicates over an air interface operating on radio frequencies with the wireless device within range of the radio network node.

Specifications for the Evolved Packet System (EPS), also called a Fourth Generation (4G) network, have been completed within the 3rd Generation Partnership Project (3GPP) and this work continues in the coming 3GPP releases, for example to specify a Fifth Generation (5G) network also referred to as 5G New Radio (NR). The EPS comprises the Evolved Universal Terrestrial Radio Access Network (E-UTRAN), also known as the Long Term Evolution (LTE) radio access network, and the Evolved Packet Core (EPC), also known as System Architecture Evolution (SAE) core network. E-UTRAN/LTE is a variant of a 3GPP radio access network wherein the radio network nodes are directly connected to the EPC core network rather than to RNCs used in 3G networks. In general, in E-UTRAN/LTE the functions of a 3G RNC are distributed between the radio network nodes, e.g. eNodeBs in LTE, and the core network. As such, the RAN of an EPS has an essentially “flat” architecture comprising radio network nodes connected directly to one or more core networks, i.e. they are not connected to RNCs. To compensate for that, the E-UTRAN specification defines a direct interface between the radio network nodes, this interface being denoted the X2 interface.

Multi-antenna techniques may significantly increase the data rates and reliability of a wireless communication system. The performance is in particular improved if both the transmitter and the receiver are equipped with multiple antennas, which results in a Multiple-Input Multiple-Output (MIMO) communication channel. Such systems and/or related techniques are commonly referred to as MIMO.

Localization of UEs has been one of the important features of LTE since 3GPP Rel. 9. Due to the regulatory requirements, a precise identification of the E911 calls origin has also been considered as one prime feature that New Radio (NR) technology should support.

To support UE positioning, system architectures, also referred to as positioning architectures, as shown in FIG. 1 and FIG. 2 have been proposed respectively for LTE and NR.

In LTE positioning architecture as illustrated in FIG. 1, LTE positioning protocol (LPP) and radio resource control (RRC) protocol are respectively devised to handle the interactions between a UE and location server also referred to as an Evolved Serving Mobile Location Centre (E-SMLC) and eNodeB and UE. In addition, an LTE positioning protocol A (LPPa) has been defined as interaction protocol between the E-SMLC and eNodeB. in FIG. 1 references are made to 3GPP Technical Specifications (TS) of relevant protocols.

Moreover, in NR as illustrated by FIG. 2, the interaction between the gNodeB and location server also referred to as a Location Management Function (LMF) is handle by NR Positioning Protocol A (NRPPa) and the interaction between an UE and a gNodeB is handled by the RRC. The interaction protocol between the LMF and UE, is done by reusing the LPP defined for LTE.

Currently Enhanced Cell ID (E-CID), global navigation satellite system (GNSS) assisted, observed time difference of arrival (OTDOA) and uplink time difference of arrival (UTDOA) based technologies are exploited for UE positioning. Depending on the localization accuracy, OTDOA has been widely accepted as one of the major positioning techniques for LTE and is also specified for 3GPP Rel. 16 work for NR positioning (NR Downlink Time Difference of Arrival); along with both UE assisted and UE based modes.

The positioning modes may be categorized in below three areas:
UE-Assisted: The UE performs measurements with or without assistance from the network and sends these measurements to the E-SMLC where the position calculation may take place. A UE using UE-assisted positioning mode may be referred to as a UE assisted UE, or UE A UE.
UE-Based: The UE performs measurements and calculates its own position with assistance from the network. A UE using UE-based positioning mode may be referred to as a UE based UE.
Standalone: The UE performs measurements and calculates its own without network assistance. A UE using Standalone positioning mode may be referred to as a standalone UE herein.

In the OTDOA, in NR, termed Downlink Time Difference Of Arrival (DL-TDOA), Positioning method, a UE requires to measure a reference signal time difference of a reference cell and reference signal time difference of at least two neighbour cells. The UE performs the time difference of arrival between the reference cell and each of the neighbour cells. A hyperbola as shown below in FIG. 3 is created and the intersection of the hyperbolas is the region where the UE is located, wherein the below formula is used to compute user location at (xᵤ, yᵤ) based upon the computed Reference Signal Time Difference (RSTD) measurements:

$$RSTD 2 , 1 = √ ( \frac{{xu - x 2 )}^{2} + {( yu - y 2 )}^{2}}{c} ) - √ ( \frac{{xu - x 1 )}^{2} + {( yu - y 1 )}^{2}}{c} )$$

In 3GPP Release 17, Dynamic Positioning Reference Signals (PRS) has been studied and most likely would be recommended for normative work.

One of the main objectives of dynamic PRS (on demand PRS) is to reduce PRS overhead.

An example scenario of signalling of LMF for PRS Overhead Reduction is illustrated in FIG. 4. The example scenario comprises a UE, a Serving gNB (SgNB), a Neighbor gNB (NgNB), and an LMF. According to the example scenario, the LMF may identify whether certain beams are contributing or not contributing to positioning measurements by following steps of the example scenario:
The LMF sends to the NgNB a Start PRS Transmission message.
The LMF also sends to the SgNB a Start PRS Transmission message.
The UE performs measurements.
The UE provides to the LMF, DL-PRS and Enhanced Cell ID (ECID) Measurement using the LTE Positioning Protocol (LPP).
The LMF may then check the PRS Utilization, e.g. the LMF may determine whether or not to enable PRS where it is currently disabled.
The LMF sends a request to the SgNB to reconfigure PRS, e.g. add and/or remove beams, using NRPPa.
The LMF sends a request to the NgNB to reconfigure PRS, e.g. add and/or remove beams, using NRPPa.
The SgNB sends an Acknowledgement (ACK) to the LMF, acknowledging the request to reconfigure PRS, e.g. add and/or remove beams, using NRPPa.
The NgNB sends an Acknowledgement (ACK) to the LMF, acknowledging the request to reconfigure PRS, e.g. add and/or remove beams, using NRPPa.

Other information such as measurement reports may be based upon a pre-requisite procedure such as ECID and Quasi Colocation (QCL) information. QCL may be used for configuring the similarity of propagation or channel properties between positioning reference signals and one or more Radio Resource Management (RRM) signals/channels characterizing RRM beams.

During OTDOA and/or DL-TDOA based positioning the location server, e.g. LMF in NR and E-SMLC in LTE, provides assistance data to a UE to perform Relative Signal Time Difference (RSTD) measurements. In NR, e.g. in Frequency Range 2 (FR2), TRPs with a neighbor beams list would also be included in the assistance data. In this way, location or positioning accuracy would be impacted based upon the selected TRPs and beams for measurement.

The ASN.1 structure for UE specific TRP or DL-PRS information as described in 3GPP TS 38.331 v 16.3.1 is provided below.

| DL-PRS-Info-r16 ::= | | SEQUENCE { |
|---|---|---|
| dl-PRS-ID-r16 | | INTEGER (0..255), |
| dl-PRS-ResourceSetId-r16 | \| | INTEGER (0..7), |

| | |
|---|---|
| dl-PRS-ResourceId-r16 | INTEGER (0..63) |
| OPTIONAL -- Need S | |
| } | |

### DL-PRS-Info Field Descriptions

Below follows a brief description of the fields comprised in the above ASN.1 structure.

dl-PRS-ID specifies the UE specific TRP ID, e.g. as further specified in 3GPP TS 37.355, for which PRS configuration is provided.

dl-PRS-ResourceSetId specifies the PRS Resource Set ID of a PRS Resource Set.

dl-PRS-ResourceId specifies a specific PRS-Resource ID of a PRS resource. If this field is absent, a UE may determine the dl-PRS-ResourceId based on its PRS measurement from the TRP and DL-PRS Resource Set.

A Geometric Dilution of Precision (GDOP) is an important attribute that may influence the accuracy of location in positioning methods which use multilateration. It describes error caused by the relative position of e.g. base stations, cells and/or beams etc. If the base stations, e.g. beams or cells, location are too close to each other and not well spread around the UE, the reported RSTD value suffers from poor GDOP resulting in a location estimation comprising a large error. However, if, e.g. the beams or the cells of the base stations, have certain distance and/or angular separation between them, it can result in a good GDOP, e.g. multilateration, which may thus identify the UE location more precisely. In a simple form, GDOP may be computed as a ratio of position error to the range error.

### Minimization of Drive Test

In 3GPP Release 16 (Rel-16) for NR, a Minimization of Drive Test (MDT) feature has been defined and may further be defined by 3GPP Release 17 (Rel-17).

MDT is used as an alternative to drive tests for obtaining certain types of UE measurements results for Self-Organizing Networks (SON) related features such as network planning, network optimization, network parameter tuning, configuring e.g. base station transmit power, number of receive and/or transmit antennas, or even for positioning e.g., Radio Frequency (RF) pattern matching based positioning.

When a UE is configured by a network node for logging measurements. two MDT modes exist: immediate MDT and logged MDT defined as follows.

Immediate MDT comprises measurement performed by the UE in high RRC activity states, e.g. RRC CONNECTED state in LTE and NR. The UE then reports the measurements to the network node e.g. eNodeB or gNodeB, when a reporting condition is met e.g. an event is triggered.

Logged MDT functionality comprises measurements performed by the UE when operating in a low RRC activity state, e.g. RRC idle and/or RRC inactive. The network node uses, e.g. sends to the UE, Logged Measurement Configuration (LMC) message to configure the UE to perform logging of measurement results in the low RRC activity state. The measurement results can be stored in the UE for up to 48 hours e.g. before reporting them to the network node. The configuration, e.g. LMC message, comprises information such as e.g. an absolute time in the cell, logging duration, logging interval or periodicity, e.g. how often the measurements are logged, and/or information about area where logging is required. The logging duration can vary from few minutes to several hours. The UE then transmits the measurement results along with relative time stamp for each log, which indicates the time of logging measurement results relative to the absolute time received and ins some cases, optional location information of the logged results.

### SUMMARY

As a part of developing embodiments herein the inventors identified a problem which first will be discussed.

Frequency bands for 5G NR are being separated into two different frequency ranges. First there is Frequency Range 1 (FR1) that includes sub-6 GHZ frequency bands, some of which are bands traditionally used by previous standards but has been extended to cover potential new spectrum offerings from 410 MHz to 7125 MHz. The other is Frequency Range 2 (FR2) that includes frequency bands from 24.25 GHz to 52.6 GHz. Bands in this millimeter wave range have shorter range but higher available bandwidth than bands in the FR1.

In FR2, PRS need to be transmitted in all or multiple beams to compensate the higher path loss at higher carrier frequencies. The PRS transmission to all beam sweeping directions results in an unnecessary transmission of PRSs and thus a mechanism is needed to select the most suitable TRPs for PRS transmission; i.e TRPs whose beam provides the best result.

Currently, a UE may report DL Reference Signal Received Power (RSRP). However, this does not consider the geometry or the positioning error that may be contributed because of poor geometry. Hence, a GDOP based result is desired.

An object of embodiments herein is to improve the method of positioning a UE in a communications network.

According to an aspect of embodiments herein, the object is achieved by a method performed by a network node for handling positioning of a User Equipment, UE, in a wireless communications network.

The network node recommends configurations for multiple Transmission Reception Points, TRPs, to transmit positioning signals. The network node further recommends a configuration for the UE to perform positioning measurement of the positioning signals transmitted by the multiple TRPs.

The network node obtains a position of the UE based on positioning measurement results of the multiple TRPs. The network node obtains errors based on uncertainty associated with the positioning measurement results of the multiple TRPs. The network node obtains a Geometric Dilution of Precision, GDOP, for the multiple TRPs based on the obtained errors and the position of the UE.

The network node then manages transmission of the positioning signals of the multiple TRPs, based on the obtained GDOP.

According to another aspect of embodiments herein, the object is achieved by a method performed by a User Equipment, UE, for handling positioning of the UE in a wireless communications network. The UE performs positioning measurement of positioning signals transmitted by multiple TRPs according to a configuration and determines information about an uncertainty associated with the respective positioning measurements of the multiple TRPs. The UE calculates a position of the UE based on positioning measurements of the multiple TRPs, calculates errors based on uncertainty associated with the positioning measurements of the multiple TRPs, and calculates a Geometric Dilution of Precision, GDOP, for the multiple TRPs based on the obtained errors and the position of the UE. The UE then transmits the GDOP to the network node to be used for managing transmission of the positioning signals of the multiple TRPs.

According to another aspect of embodiments herein, the object is achieved by a network node configured to handle positioning of a User Equipment, UE, in a wireless communications network. The network node is further configured to:
Recommend, configurations for multiple Transmission Reception Points, TRPs, to transmit positioning,
recommend, a configuration for the UE to perform positioning measurement of the positioning signals transmitted by the multiple TRPs,
obtain a position of the UE based on positioning measurement results of the multiple TRPs,
obtain errors based on uncertainty associated with the positioning measurement results of the multiple TRPs,
obtain a Geometric Dilution of Precision, GDOP, for the multiple TRPs based on the obtained errors and the position of the UE, and
manage transmission of the positioning signals of the multiple TRPs, based on the obtained GDOP.

According to another aspect of embodiments herein, the object is achieved by a User Equipment, UE, configured to handle positioning of the UE in a wireless communications network. The UE is further configured to:
Perform positioning measurement of positioning signals transmitted by multiple TRP according to a configuration,
determine information about an uncertainty associated with the respective positioning measurements of the multiple TRPs,
calculate a position of the UE based on positioning measurements of the multiple TRPs,
calculate errors based on uncertainty associated with the positioning measurements of the multiple TRPs, and
calculate a Geometric Dilution of Precision, GDOP, for the multiple TRPs based on the obtained errors and the position of the UE, and
transmit the GDOP to the network node to be used for managing transmission of the positioning signals of the multiple TRPs.

It is furthermore provided herein a computer program product comprising instructions, which, when executed on at least one processor, cause the at least one processor to carry out any of the methods above, as performed by the apparatus. It is additionally provided herein a computer-readable storage medium, having stored there on a computer program product comprising instructions which, when executed on at least one processor, cause the at least one processor to carry out the method according to any of the methods above, as performed by the apparatus.

### BRIEF DESCRIPTION OF THE DRAWINGS

Examples of embodiments herein are described in more detail with reference to attached drawings in which:

FIG. 1 is a schematic block diagram illustrating prior art.

FIG. 2 is a schematic block diagram illustrating prior art.

FIG. 3 is a schematic diagram illustrating prior art.

FIG. 4 is a sequence diagram illustrating prior art.

FIG. 5 is a schematic block diagram illustrating embodiments of a wireless communications network.

FIG. 6 is a flowchart depicting embodiments of a method in a network node.

FIG. 7 is a flowchart depicting embodiments of a method in a UE.

FIG. 8a is a flowchart depicting embodiments of a method.

FIG. 8b is a flowchart depicting embodiments of a method.

FIGS. 9 a and b are schematic block diagrams illustrating embodiments of a network node.

FIGS. 10 a and b are schematic block diagrams illustrating embodiments of a UE.

FIG. 11 schematically illustrates a telecommunication network connected via an intermediate network to a host computer.

FIG. 12 is a generalized block diagram of a host computer communicating via a base station with a user equipment over a partially wireless connection.

FIGS. 13-16 are flowcharts illustrating methods implemented in a communication system including a host computer, a base station and a user equipment.

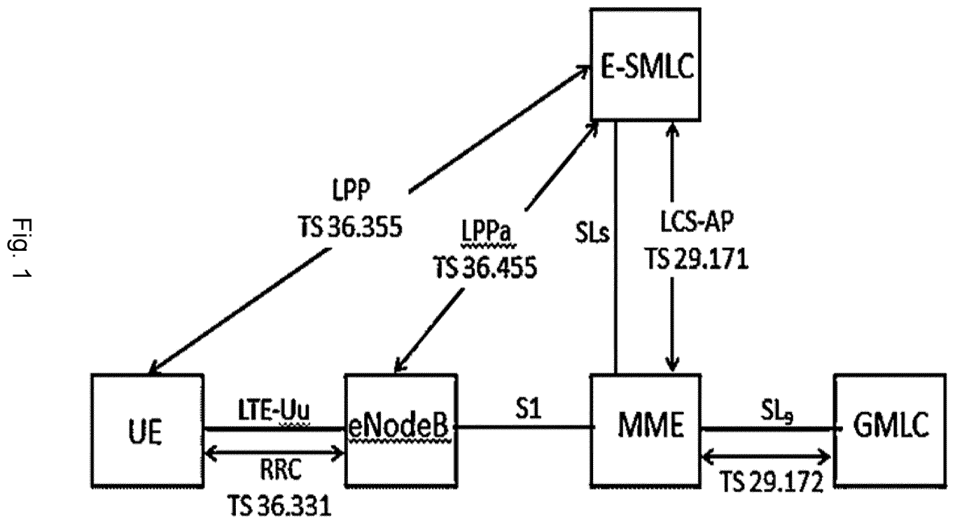

### DETAILED DESCRIPTION

Some example embodiments herein provide mechanisms on how a GDOP result is provided by an entity that computes positioning.

Further, some example embodiments herein provide methods to Signal GDOP Results in a wireless communications network such as a Cellular Network.

E.g., GDOP is calculated based upon positioning error and ranging error. Ranging error may be calculated first and then a positioning of the UE is estimated; and an error is computed based upon all the uncertainties in positioning calculation such as error during RSTD/TDOA computations. Co-relation error, multipath/Non Line of sight, ranging error etc.

E.g., for a UE based positioning mode, the UE is able to compute GDOP and for UE-Assisted positioning mode, a network node such as an LMF may compute the GDOP.

Embodiments herein e.g. provide the following advantages:
PRS Overhead is reduced.
A feature similar to Self-optimized Network which may take GDOP result and learn, e.g. by artificial Intelligence/Machine Learning re-enforcement-based learning, which TRPs to continue with PRS transmission and which to stop.
The UE may log the GDOP result along with location information and may provide to a node in the wireless communications network for PRS overhead reduction.

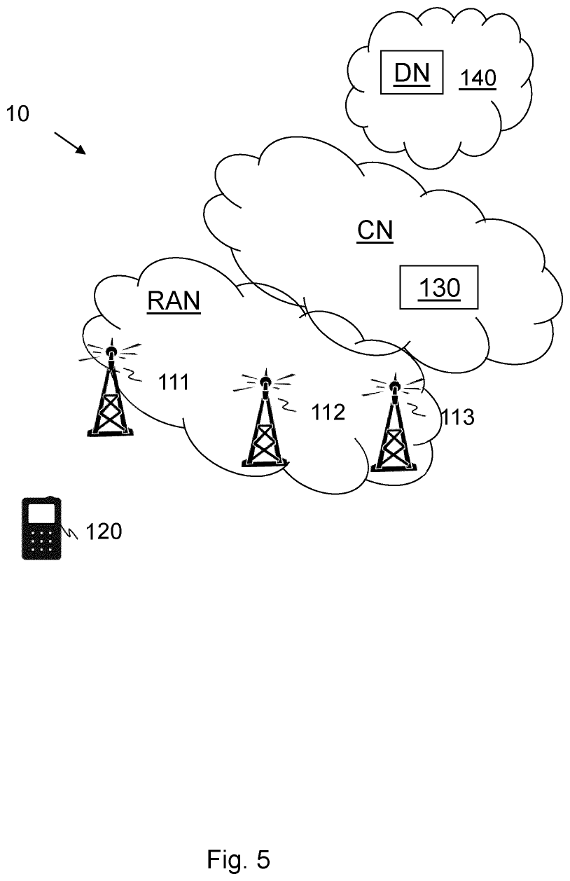

FIG. 5 is a schematic overview depicting a wireless communications network 10 wherein embodiments herein may be implemented. The wireless communications network 10 comprises one or more RANs and one or more CNs. The wireless communications network 10 may use 5G NR but may further use a number of other different technologies, such as, Wi-Fi, (LTE), LTE-Advanced, Wideband Code Division Multiple Access (WCDMA), Global System for Mobile communications/enhanced Data rate for GSM Evolution (GSM/EDGE), or Ultra Mobile Broadband (UMB), just to mention a few possible implementations.

Network nodes such as multiple TRPs 111, 112, 113 operate in the wireless communications network 10, by means of antenna beams, referred to as beams herein. The multiple TRPs 111, 112, 113, may each e.g. provide a number of cells, and may use these cells for communicating with e.g. a UE 120. TRPs 111, 112, 113 may each be a transmission and reception point e.g. a radio access network node such as a base station, e.g. a radio base station such as a NodeB, an evolved Node B (eNB, eNode B), an NR Node B (gNB), a base transceiver station, a radio remote unit, an Access Point Base Station, a base station router, a transmission arrangement of a radio base station, a stand-alone access point, a Wireless Local Area Network (WLAN) access point, an Access Point Station (AP STA), an access controller, a UE acting as an access point or a peer in a Device to Device (D2D) communication, or any other network unit capable of communicating with a UE within any cells served by the multiple TRPs 111, 112, 113 depending e.g. on the radio access technology and terminology used.

User Equipments operate in the wireless communications network 10, such as a UE 120. The UE 120 may provide radio coverage by means of a number of antenna beams 127, also referred to as beams herein.

The UE 120 may e.g. be an NR device, a mobile station, a wireless terminal, an NB-IoT device, an eMTC device, an NR RedCap device, a CAT-M device, a WiFi device, an LTE device and an a non-access point (non-AP) STA, a STA, that communicates via a base station such as e.g. the network node 110, one or more Access Networks (AN), e.g. RAN, to one or more core networks (CN). It should be understood by the skilled in the art that the UE relates to a non-limiting term which means any UE, terminal, wireless communication terminal, user equipment, (D2D) terminal, or node e.g. smart phone, laptop, mobile phone, sensor, relay, mobile tablets or even a small base station communicating within a cell.

Network nodes such as a network node 130 operates in the wireless communications network 10. The network node 130 may e.g. be a CN node, e.g. an LMF such as ab LMF node.

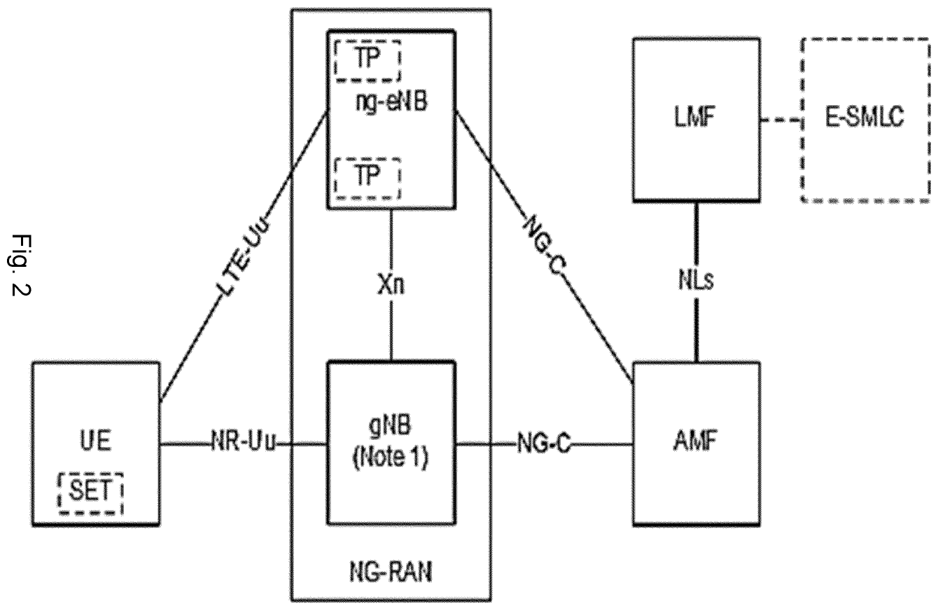

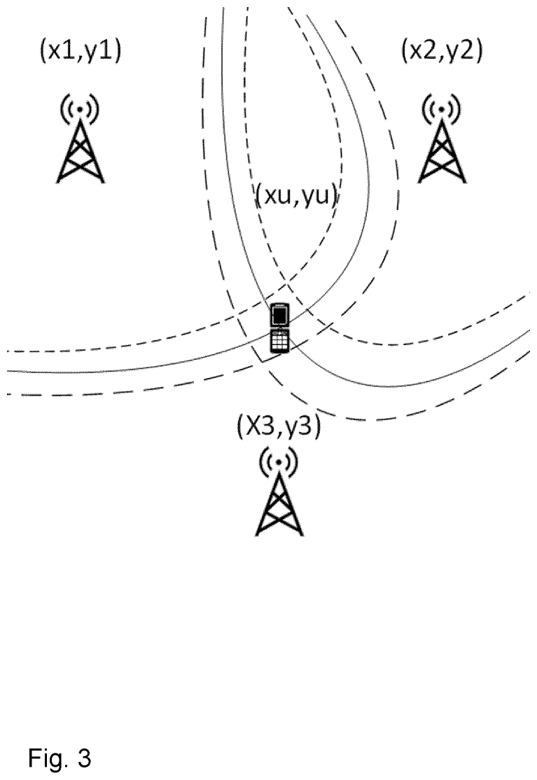

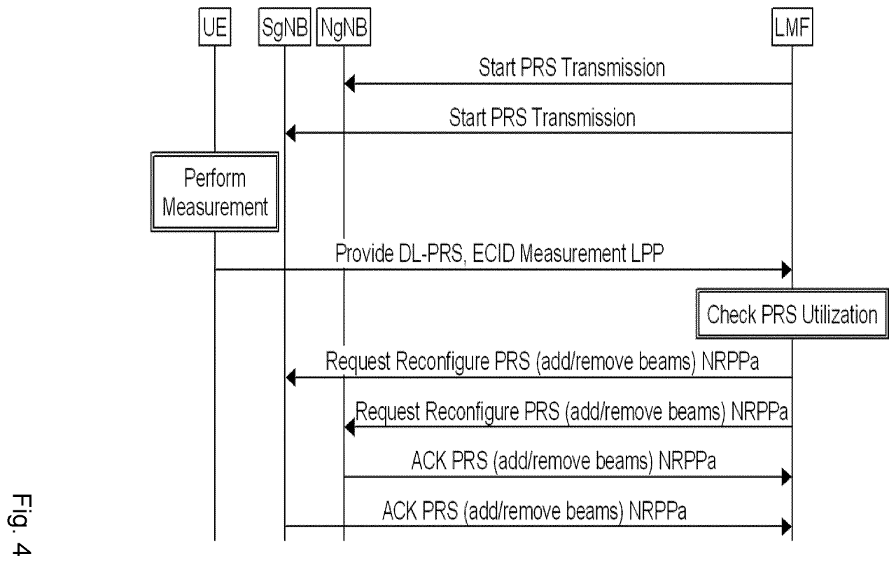

Methods herein may in one aspect be performed by the network node 130, in another aspect by the UE 120. As an alternative, a Distributed Node (DN) and functionality, e.g. comprised in a cloud 140 as shown in FIG. 2, may be used for performing or partly performing the methods.

### Terminology

Herein, the term “GDOP result” or “GDOP information” may correspond to a ratio of position error to the range error (low GDOP implies better accuracy). It may be computed based on the location of the base-station and UE. A below GDOP Threshold result implies here a worse and/or bad GDOP result whereas above threshold implies that the GDOP is better. However, it should be noted that GDOP results as such may be graded from 1 to 20; where 1 is the best and 20 is the worst.

Herein, the term “Position quality” may corresponds to an indicator of the position estimation error. Position quality might be proportional to GDOP in case of LOS conditions. However, it may differ in NLOS channel conditions. In NR, the term Position quality would be defined considering NR beams angular and SNR information

Herein, the term “positioning measurement” may comprise e.g. any of: timing-based positioning measurement, TDOA, TOA, RSTD, OTDOA measurement, UE Rx-Tx measurement involving measuring a signal from a neighbor cell, etc.

RSTD-Quality: This field specifies the target device's, e.g. the UE 120, best estimate of the quality of the measured RSTD.

Herein, the term “positioning signal” may comprise, e.g., any signal or channel to be received by the UE for performing a positioning measurement such as a DL reference signal, PRS, SSB, synchronization signal, DM-RS, CSI-RS, etc.

Herein, the term “beam” implies that a cell is using “beamforming” which may comprise any of: a cell consisting of or comprising multiple beams, transmitting two or more SSBs in a single cell from the same location, using analog beamforming in the transmitting node, using digital beamforming in the transmitting node, using hybrid beamforming in the transmitting node, possibility of transmitting different signals in two or more different directions in the same cell from the same location, transmitting signals from different transmitter branches (comprising one or more antenna elements), transmitting in a mmwave frequency range or FR2 or above 6 GHz. A UE may determine and/or report the number of detected beams, per cell or per carrier. There may also be UE measurement capability in terms the maximum number of beams the UE is expected to be able to handle at the same time. In some cases, a beam may be associated with an SSB ID (on a carrier where SSBs are present) or other signal ID such as DM-RS ID or CSI-RS ID (e.g., on carriers where SSBs are not transmitted but other signals are used to differentiate beams). Furthermore, a positioning signal may be associated with a beam via a co-location or quasi-colocation property with respect to a signal characterizing the beam, e.g., co-located or quasi-collocated with the corresponding SSB and/or CSI-RS. Herein, the terms “beamforming configuration” and “beam configuration” may be interchangeably used. Herein, the term “type of beam” may comprise a beam characterized by a specific property in one or more of: beam coverage (beams with small coverage, macro coverage, etc.), beam width, beam size, beam orientation (vertical, horizontal, etc.), environment (indoor beam or outdoor beam), mobility (statically or semi-statically configured beam or moving beam), etc.

The terms “base station” and/or “TRP” are generically used to denote a network node or transmitting point transmitting radio signals. It may be a base station, gNB, TRP, TP, a transmitter with a distributed antenna system, RRH, positioning beacon, another UE or device transmitting radio signals to be used for positioning by other UEs, a etc. The base station may communicate with other network nodes, e.g., another base station, location server, etc.

The term “location server” is used herein to denote a network node with positioning functionality, e.g., ability to provide assistance data and/or request positioning measurements and/or calculate a location based on positioning measurements. Location server may or may not reside in a base station.

Embodiments herein further provides any one or more out of:
DL PRS RSTD measurements is supported inactive mode.
GDOP result is provided to the network node 130, e.g. an LMF, by the UE 120 operating in UE based mode.
A deployment to specify which positioning mode the UE 120 may operate in via broadcast.

According to embodiments herein, GDOP results may be used for RAN management, such as managing transmission of positioning signals of the multiple TRPs 111, 112, 113, based on the obtained GDOP.

Embodiments herein may further provide positioning signalling such as PRS overhead reduction. The UE may log GDOP results as part of MDT/SON Feature.

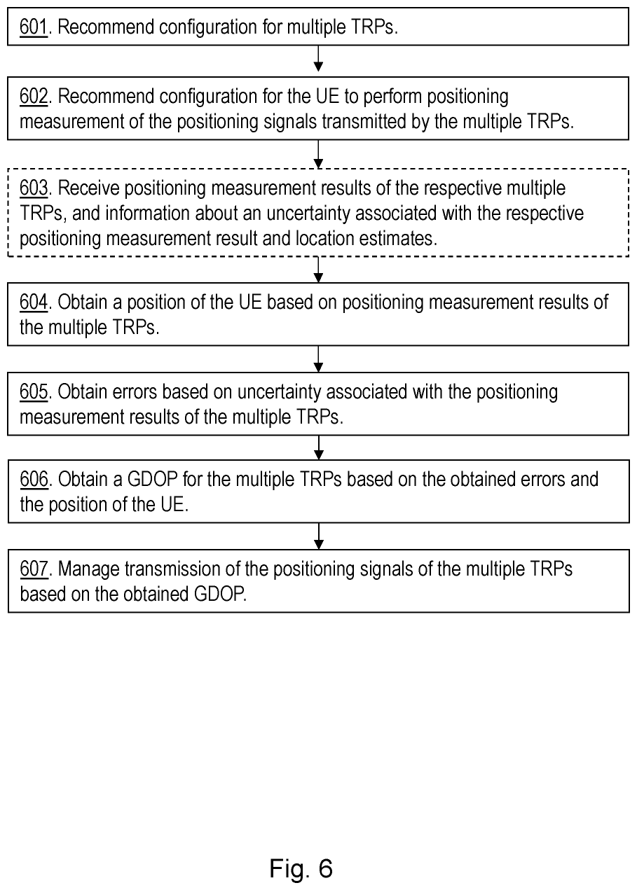

FIG. 6 shows an example method performed by the network node 130, e.g. LMF, e.g. for handling positioning of the UE 120 in the wireless communications network 10. The UE 120 may e.g. operate in UE Assisted (UE-A) or UE Based (UE-B) positioning mode. The method comprises any one or more out of the actions below. Optional actions are illustrated as dashed boxes in FIG. 6.

### Action 601

The network node 130 may configure for the multiple TRPs, 111, 112, 113 to transmit positioning signals e.g. in one or more resources such as beams. So configure here involves to recommend the configuration. This may be performed by the network node 130 that recommends configuration for the multiple TRPs, 111, 112, 113 to transmit positioning signals.

### Action 602

The network node 130 may configure the UE 120 to perform positioning measurement of the positioning signals transmitted by the multiple TRPs 111, 112, 113. Thus, configure here may involve recommending a configuration. This may be performed by the network node 130 that recommends a configuration for the UE 120 to perform positioning measurement of the positioning signals transmitted by the multiple TRPs 111, 112, 113.

In some embodiments this may relate to action 100 below.

### Action 603

In some embodiments, the network node 130 receives positioning measurement results of the respective multiple TRPs 111, 112, 113, and information about an uncertainty associated with the respective positioning measurement result and location estimates. This may be performed in some embodiments where the UE 120 operates in UE Based positioning mode.

In some embodiments the UE 120 operates in UE Based positioning mode, and may compute position that may be sent to the network node 130 along with GDOP results.

In some embodiments the UE 120 operates in UE assisted positioning mode and may not compute position and it needs LMF to do it. So, it may send the measurement results, e.g. a report, report and the network node 130 such as e.g. an LMF computes GDOP.

In some embodiments this may relate to action 200 below.

### Action 604

The network node 130 obtains a position of the UE 120 based on positioning measurement results of the multiple TRPs 111, 112, 113.

In some embodiments the network node 130 obtains the position of the UE 120, based on the positioning measurement results of the multiple TRPs 111, 112, 113, by calculating the position of the UE 120 based on the positioning measurement results of the multiple TRPs 111, 112, 113. This may be performed in some embodiments where the UE 120 operates in UE assisted positioning mode.

In some embodiments, the position of the UE 120 based on the positioning measurement results of the multiple TRPs 111, 112, 113, is obtained by receiving it from the UE 120. This may be performed in some embodiments where the UE 120 operates in UE based positioning mode.

In some embodiments this may relate to action 300 below.

### Action 605

The network node 130 obtains errors based on uncertainty associated with the positioning measurement results of the multiple TRPs 111, 112, 113.

The location accuracy related to the positioning measurement results may be estimated with certain uncertainty as defined in 3GPP TS 23.032 and confidence as defined in 3GPP TS 23.032.

In some embodiments the network node 130 obtains errors based on uncertainty associated with the positioning measurement results of the multiple TRPs 111, 112, 113, by calculating the errors based on uncertainty associated with the positioning measurement results of the multiple TRPs 111, 112, 113. This may be performed in some embodiments where the UE 120 operates in UE assisted positioning mode.

In some embodiments, the errors based on uncertainty associated with the positioning measurement results of the multiple TRPs 111, 112, 113, is obtained by receiving it from the UE 120. This may be performed in some embodiments where the UE 120 operates in UE based positioning mode.

In some embodiments this may relate to action 300 below.

### Action 606

The network node 130 obtains a GDOP for the multiple TRPs 111, 112, 113 based on the obtained errors and the position of the UE 120.

In some embodiments, the network node 130 obtains a GDOP for the multiple TRPs 111, 112, 113 based on the obtained errors and the position of the UE 120, is obtained by calculating 300, 606 a GDOP for the multiple TRPs 111, 112, 113 based on the obtained errors and the position of the UE 120. This may be performed in some embodiments where the UE 120 operates in UE assisted positioning mode.

In some embodiments, the GDOP for the multiple TRPs 111, 112, 113 based on the obtained errors and the position of the UE 120, is obtained by receiving it from the UE 120. This may be performed in some embodiments where the UE 120 operates in UE based positioning mode.

In some embodiments the obtaining of the GDOP for the multiple TRPs 111, 112, 113 further comprises obtaining from the UE 120, the logged GDOP for PRS overhead reduction.

In some embodiments the obtaining of the GDOP for the multiple TRPs 111, 112, 113 further comprises a report of whether the GDOP results are based upon assistance data received in broadcast.

In some embodiments the obtaining of the GDOP for the multiple TRPs 111, 112, 113 further comprises a cell Identity (ID) list of corresponding TRPs 111, 112, 113 that was used for GDOP result. In some embodiments the obtaining of the GDOP further comprises providing sorted TRPs based upon the GDOP result for the multiple TRPs 111, 112, 113 comprising a respective rating category according to any one out of: No measurement, Poor, Fair, Moderate, Good, Excellent, Excellent, Ideal, or No measurement.

In some embodiments the obtaining of the GDOP for the multiple TRPs 111, 112, 113 is provided as part of a MDT, and/or SON logged result.

In some embodiments this may relate to action 300 below.

### Action 607

The network node 130 manages transmission of the positioning signals of the multiple TRPs 111, 112, 113, based on the obtained GDOP and in some embodiments, the calculated, also referred to as estimated position of the UE 120. The position of the UE 120 may be referred to as location of the UE 120.

In some embodiments, the network node 130 obtains the location of the UE 120 and corresponding GDOP and uses this information to manage transmission of the positioning signals of the multiple TRPs 111, 112, 113, e.g. PRS transmission.

In some embodiments the network node 130 manages the transmission of the positioning signals from the one or more TRPs 111, 112, 113 comprises any one or more out of:

When the obtained GDOP is below a threshold at a certain location, reconfiguring one or more TRPs among the multiple TRPs 111, 112, 113 to stop transmitting positioning signals to e.g. perform positioning signalling overhead reduction by, which one or more TRPs e.g. was contributing to make the obtained GDOP below said threshold or poor GDOP.

In some embodiments the network node 130 decides whether or not to reconfigure one or more TRPs among the multiple TRPs 111, 112, 113 to transmit positioning signals based on the obtained GDOP.

In some embodiments this may relate to action 400 below.

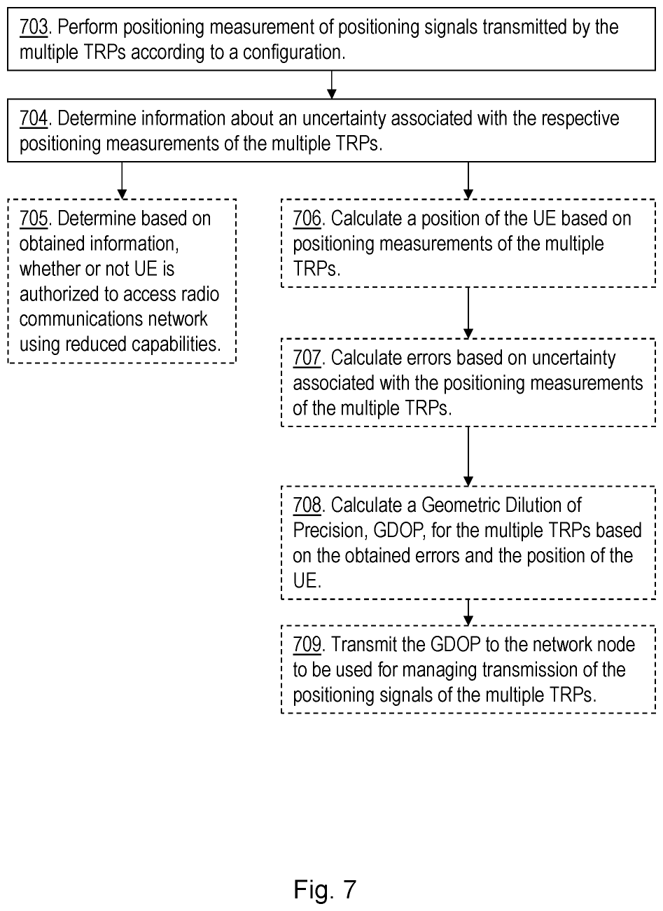

FIG. 7 shows an example method performed by the UE 120 e.g. for handling positioning of the UE 120 in the wireless communications network 10. As mentioned above, the UE 120 may e.g. operate in UE Assisted (UE-A) or UE Based (UE-B) positioning mode. The method comprises any one or more out of the actions below: Optional actions are illustrated as dashed boxes in FIG. 7.

### Action 703

The UE 120 performs positioning measurement of positioning signals transmitted by the multiple TRPs 111, 112, 113 according to a configuration.

In some embodiments this may relate to action 100 below.

### Action 704

The UE 120 determines information about an uncertainty associated with the respective positioning measurements of the multiple TRPs 111, 112, 113.

In some embodiments this may relate to action 300 below.

### Action 705

In some embodiments, the UE 120 sends the positioning measurement results and information about the uncertainty associated with the respective positioning measurements of the multiple TRPs 111, 112, 113 to the network node 130 to be used for managing transmission of the positioning signals of the multiple TRPs 111, 112, 113. This may be performed in some embodiments where the UE 120 operates in UE assisted positioning mode.

### Action 706

In some embodiments, the UE 120 calculates, also referred to as estimates, a position of the UE 120 based on positioning measurements of the multiple TRPs 111, 112, 113. This may be performed in some embodiments where the UE 120 operates in UE Based positioning mode.

In some embodiments this may relate to action 100 below.

Action 707

In some embodiments, the UE 120 calculates errors based on uncertainty associated with the positioning measurements of the multiple TRPs 111, 112, 113. This may be performed in some embodiments where the UE 120 operates in UE Based positioning mode.

In some embodiments this may relate to action 300 below.

### Action 708

In some embodiments, the UE 120 calculates a GDOP for the multiple TRPs 111, 112, 113 based on the obtained errors and the position of the UE 120. This may be performed in some embodiments where the UE 120 operates in UE Based positioning mode.

The calculating of the GDOP may further comprise a logging of the GDOP result. The logging the GDOP comprises any one or more out of:
Logging of GDOP and identifying the group of multiple TRPs 111, 112, 113 based upon GDOP, to provide high quality location accuracy, and
logging of GDOP and identifying the group of TRPs based upon GDOP to provide low quality location accuracy.

In some embodiments this may relate to action 300 below.

### Action 709

In some embodiments, the UE 120 transmits the GDOP to the network node 130 to be used for managing transmission of the positioning signals of the multiple TRPs 111, 112, 113. This may be performed in some embodiments where the UE 120 operates in

UE Based positioning mode.

The transmitting to the network node 130 may further comprise transmitting the logged GDOP for PRS overhead reduction.

In some embodiments, the transmitting to the network node 130 further comprises a report of whether the GDOP results are based upon assistance data received in broadcast.

In some embodiments, the transmitting to the network node 130 further comprises a cell ID list of corresponding TRPs 111, 112, 113 that was used for GDOP result.

In some embodiments, the transmitting of the logged GDOP to the network node 130 is provided to the network node 130 as part of a MDT and/or SON logged result.

The transmitting to the network node 130 may further comprise a GDOP result for the multiple TRPs 111, 112, 113 comprising a respective rating category according to any one or more out of: No measurement, Poor, Fair, Moderate, Good, Excellent, Excellent, Ideal, or No measurement.

In some embodiments this may relate to action 300 below.

The method will now be further explained and exemplified in below embodiments. These below embodiments may be combined with any suitable embodiment as described above.

The UE 120 may perform logging of GDOP and identifying the group of multiple TRPs 111, 112, 113 based upon GDOP, which provides high quality location accuracy.

The UE 120 may perform logging of GDOP and identifying the group of TRPs 111, 112, 113 based upon GDOP which provides low quality location accuracy.

The UE 120 may provide GDOP result along with an estimated location, i.e. position of the UE 120.

The UE 120 may report whether the GDOP results are based upon Assistance data received in broadcast, e.g. RRC, or LPP in Unicast, also referred to as BroadcastBasedMeasurement.

The UE 120 may provide the reference TRP ID and the reference cell ID for the computed GDOP.

The UE 120 may provide the cell ID list of corresponding TRP that was used for GDOP result.

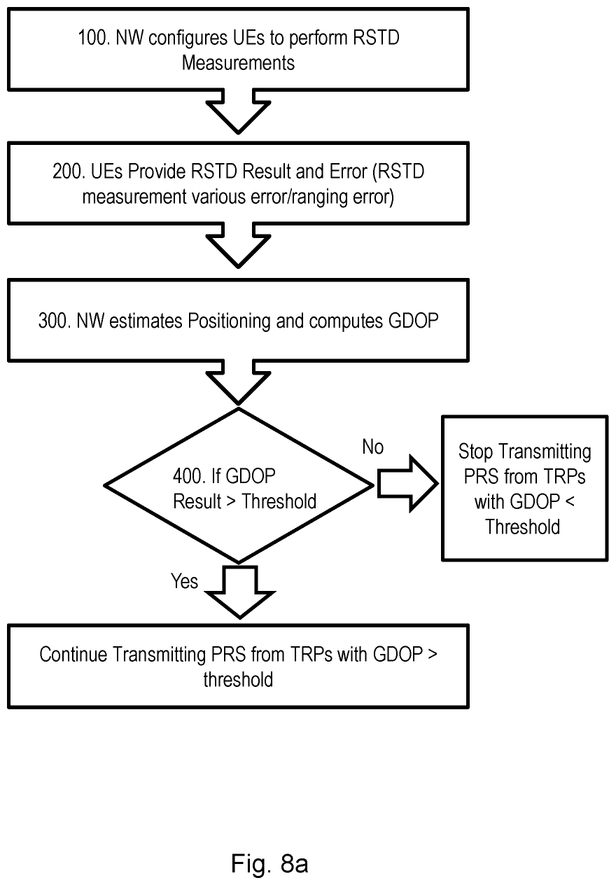

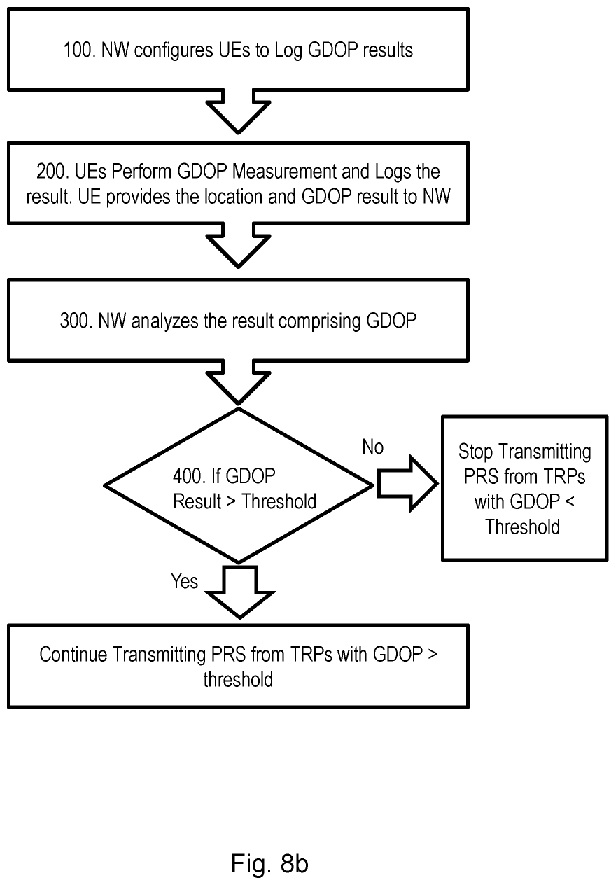

Diagrams in FIGS. 8a and 8b illustrate examples of the method related to some embodiments herein. In these figures, the network node 130 is referred to as NW.

Actions in example embodiments depicted in FIG. 8a:

Action 100 in FIG. 8a. The network node 130 configures UEs, such as the UE 120, to perform RSTD Measurements.

Action 200 in FIG. 8a. UEs, such as the UE 120, provide RSTD Result and Error, e.g. RSTD measurement comprising various error and/or ranging error.

Action 300 in FIG. 8a. The network node 130 estimates positioning and computes GDOP.

Action 400 in FIG. 8a. Is GDOP Result>Threshold? If no, Stop Transmitting PRS from TRPs with GDOP<Threshold. If yes, Continue Transmitting PRS from TRPs with GDOP>threshold.

Actions in example embodiments depicted in FIG. 8b:

100 in FIG. 8b. The network node 130 configures UEs, such as the UE 120, to Log GDOP results.

200 in FIG. 8b. UEs, such as the UE 120, perform GDOP Measurement and Logs the result. UE provides the location and GDOP result to the network node 130.

300 in FIG. 8b. the network node 130 analyzes the result comprising GDOP

400 in FIG. 8b. Is GDOP Result>Threshold? If no, Stop Transmitting PRS from TRPs with GDOP<Threshold. If yes, continue Transmitting PRS from TRPs with GDOP>threshold.

Action 300 differs for embodiments in FIG. 8b where the UE 120 operates in UE Based positioning mode, where GDOP value may be provided by UE 120 to the network node 130 and based upon this the network node 130 may take the decision.

An advantage as seen from UE 120 perspective would be that UE 120 logs the GDOP result when it computes the positioning and provides to a network node such as e.g. the network node 130, as part of MDT/SON logged result. Both immediate and Logged measurement reporting is possible.

### Signaling

### GDOP Representation e.g. to be Applied in Embodiments Herein.

As such in the literature, Dilution Of Precision (DOP). may be depicted with below values that may be used in embodiments herein.

| DOP | | |
|---|---|---|
| Value | Rating | Description |
| 1 | Ideal | Highest possible confidence level to be used for |
| | | applications demanding the highest possible |
| | | precision at all times. |
| 1-2 | Excellent | At this confidence level, positional measurements |
| | | are considered accurate enough to meet all but the |
| | | most sensitive applications. |
| 2-5 | Good | Represents a level that marks the minimum |
| | | appropriate for making accurate decisions. |
| | | Positional measurements may be used to make |
| | | reliable in-route navigation suggestions to the user. |
| 5-10 | Moderate | Positional measurements may be used for calculations, |
| | | but the fix quality may still be improved. |
| | | A more open view of the sky is recommended. |
| 10-20 | Fair | Represents a low confidence level. Positional |
| | | measurements should be discarded or used only to |
| | | indicate a very rough estimate of the current location. |
| >20 | Poor | At this level, measurements are inaccurate by as |
| | | much as 300 meters with a 6-meter accurate device |
| | | (50 DOP × 6 meters) and should be discarded. |

In some embodiments it is claimed that a X-bit variable is defined which represents the above 6 values and in addition one of the bit pattern can represent No measurement and another to represent error while computing GDOP or reserved for future use as shown below.

Below is a representation with 3 bits; or Integer value 0 to 7 shown.

| DOP Value | Rating |
|---|---|
| 000 | No measurement |
| 001 | Ideal |
| 010 | Excellent |
| 011 | Good |
| 100 | Moderate |
| 101 | Fair |
| 110 | Poor |
| 111 | Error/Reserved |

Alternately only 2-bits may be used; For example:

000->Excellent

001->Good

010->Poor

Represented by enumeration

ENUMERATED {excellent, good, poor, noResult}

GDOP Reporting from the UE 120

It should be noted that the words position and location may be used interchangeably.

In some embodiments, the UE based UE 120 may also include the GDOP while reporting Location Information; i.e. which TRPs of the multiple TRPs 111, 112, 113 contributed the best result while providing location at the particular location.

The UE 120 may have obtained the TRP IDs from LPP dedicated signaling or from broadcast AD. For TRP reporting from broadcast posSIB based, the UE 120 may inform which cell ID the TRP ID belonged to or basically performed the measurement. “posSIB based” when used herein means system information broadcast of positioning assistance data.
NR DL-TDOA Location Information
NR-DL-TDOA-ProvideLocationInformation

The IE NR-DL-TDOA-ProvideLocationInformation is used by a target device, such as the UE 120, to provide NR DL-TDOA location measurements to the location server such as the network node 130. It may also be used to provide NR DL-TDOA positioning specific error reason.

-- ASN1START
NR-DL-TDOA-ProvideLocationInformation-r16 ::= SEQUENCE {
nr-DL-TDOA-SignalMeasurementInformation-r16

NR-DL-TDOA-SignalMeasurementInformation-r16

OPTIONAL,

| | |
|---|---|
| nr-dl-tdoa-LocationInformation-r16 | NR-DL-TDOA-LocationInformation-r16 |

OPTIONAL, -- Cond

UEB

| | | |
|---|---|---|
| nr-DL-TDOA-Error-r16 | NR-DL-TDOA-Error-r16 | OPTIONAL, |

...,

| | | |
|---|---|---|
| nr-GDOP-Result-r17 | NR-GDOP-Result-r17 | OPTIONAL -- Cond UEB |

}
-- ASN1STOP

| Conditional | |
|---|---|
| presence | Explanation |
| UEB | The field is mandatory present for the UE |
| | based NR DL-TDOA; otherwise it is not present. |

-- ASN1START
NR-GDOP-Result-r17 ::= SEQUENCE {

| nr-GDOP-Value-r17 | INTEGER (0..7) OPTIONAL, | |
|---|---|---|
| nr-GDOP-TRPList-r17 | SEQUENCE (SIZE(1..nrMaxTRPs-r16)) OF INTEGER (0..255) OPTIONAL, | |
| nr-GDOP-Cellist-r17 | SEQUENCE (SIZE(1..nrMaxTRPs-r16)) OF INTEGER (0..1007) OPTIONAL, | |
| isBroadCastBasedMeasurement-r17 ENUMERATED (true) | | OPTIONAL, |
| nr-physicalCel\|lID-r17 | INTEGER (0..1007) | OPTIONAL, |
| referenceTRP-ID-r17 | INTEGER (0..255) | OPTIONAL, |

| | |
|---|---|
| nr-TimeStamp-r16 | NR-TimeStamp-r16 |

...
}
-- ASN1STOP

### NR-GDOP-Result Field Descriptions

nr-GDOP-Value This field is used to indicate the quality of geometric dilution of precision. The value 0 indicates result unavailable, value 1 indicates ideal, 2 indicates excellent, 3 indicates good, 4 indicates moderate, 5 indicates failr, 6 indicates poor

nr-GDOP-TRPList This field specifies the DL PRS ID (UE associated TRP ID) which was used for measurement and which constituted in GDOP

nr-GDOP-CellList This field specifies the cell ID where the TRP resides. The order of cell ID is same as the nr-GDOP-TRPList.

isBroadcastBasedMeasurement This field specifies whether the UE used dedicated signalling or broadcast signalling to read the TRPs information for positioning measurements

nr-PhysCellID This field specifies the physical cell identity of the associated reference TRP, as defined in TS 38.331 [35].

reference TRP-ID This field specifies the ID of the reference TRP or UE associated DL-PRS-ID.

nr-TimeStamp This field specifies the time instance at which the measurement is performed.

It is also possible to append the below location information from the UE 120 to report GDOP.
NR-DL-TDOA-LocationInformation

The IE NR-DL-TDOA-LocationInformation is included by the target device such as the UE 120 when location information derived using NR DL-TDOA is provided to the location server such as the network node 130.

| -- ASN1START | | |
|---|---|---|
| NR-DL-TDOA-LocationInformation-r16 ::= SEQUENCE { | | |
| measurementReferenceTime-r16 | CHOICE { | |
| systemFrameNumber-r16 | NR-TimeStamp-r16, | |
| utc-time-r16 | UTCTime, | |
| ... | | |
| } | | OPTIONAL, |
| ..., | | |
| nr-GDOP-Result-r17 | NR-GDOP-Result-r17 | OPTIONAL |

}
-- ASN1STOP

In an alternate embodiment it is claimed that the UE 120 using SON/MDT feature stores the GDOP result. The UE 120 may in such case report multiple GDOP result categorize in Excellent, Good, Poor e.g. to the network node 130. This measurement may be part of the measurement report or logged MDT report sent by the UE 120. In some further embodiments, the MDT results are logged only when the GDOP result are better than a threshold category, e.g., GDOP result have to be Good or Excellent.

NR-GDOP-Result-r17 ::= SEQUENCE {

| | |
|---|---|
| nr-GDOP-ExcellentTRPList-r17 | SEQUENCE (SIZE(1..nrMaxTRPs-r16)) OF INTEGER (0..255) |

OPTIONAL,

| | |
|---|---|
| nr-GDOP-GoodTRPList-r17 | SEQUENCE (SIZE(1..nrMaxTRPs-r16)) OF INTEGER (0..255) |

OPTIONAL,

| | |
|---|---|
| nr-GDOP-PoorTRPList-r17 | SEQUENCE (SIZE(1..nrMaxTRPs-r16) ) OF INTEGER (0..255) |

OPTIONAL,
...
}
-- ASN1STOP

Further, in some embodiments, the GDOP result may be part of a normal RRM measurement reporting framework in NR wherein e.g. the network (RRC) or the network node 130 may configure the UE 120 with a measurement report configuration wherein the UE 120 is expected to trigger a measurement report when one or more of the following conditions are met;
1) The GDOP result category (Excellent, Good, Poor) for a specific TRP is a pre-configured category→e.g., GDOP result of TRP1 is Good
2) The GDOP result category (Excellent, Good, Poor) for a specific TRP is one amongst a pre-configured category list→e.g., GDOP result of TRP1 is either Good or Excellent
3) The GDOP result category (Excellent, Good, Poor) for at least one TRP is a pre-configured category→e.g., GDOP result of any TRP is Good
4) The GDOP result category (Excellent, Good, Poor) for at least one TRP is one amongst a pre-configured category list→e.g., GDOP result of any TRP is either Good or Excellent
5) The GDOP result category (Excellent, Good, Poor) for at least one specific TRP amongst a configured set of TRPs is a pre-configured category→e.g., GDOP result of TRP1/TRP2/TRP3 is Good
6) The GDOP result category (Excellent, Good, Poor) for at least specific TRP amongst a configured set of TRPs is one amongst a pre-configured category list→e.g., GDOP result of TRP1/TRP2/TRP3 is either Good or Excellent
7) The GDOP result category (Excellent, Good, Poor) for all of the configured set of TRPs are a pre-configured category→e.g., GDOP result of TRP1 and TRP2 and TRP3 is Good.
8) The GDOP result category (Excellent, Good, Poor) for all of the configured set of TRPs is one amongst a pre-configured category list→e.g., GDOP result of TRP1 and TRP2 and TRP3 is either Good or Excellent

The category of the GDOP result may also be referred to as a rating category. The TRPs 111, 112, 113 are also referred to as TRP1, TRP2 and TRP3 herein.

When the above-mentioned conditions are met, the UE 120 may send a measurement report to the network, e.g. the network node 130. Based on this measurement report, the network e.g. the network node 130 may perform at least one of the following actions.
1) Trigger an MDT procedure knowing that the positioning measurements' quality would be good based on the previously received GDOP results.
2) Stop an ongoing MDT procedure knowing that the positioning measurements' quality would be bad based on the previously received GDOP results.
3) Inform the location server, e.g. the network node 130, about the current quality of the GDOP at the UE 120 so that the location server may initiated the positioning reporting.
4) Inform the location server, e.g. the network node 130, about the current quality of the GDOP at the UE 120 so that the location server may stop the positioning reporting.

The above example is shown for DL-TDOA; however, this may be used for other UE based positioning method such as DL-Angle of Departure.

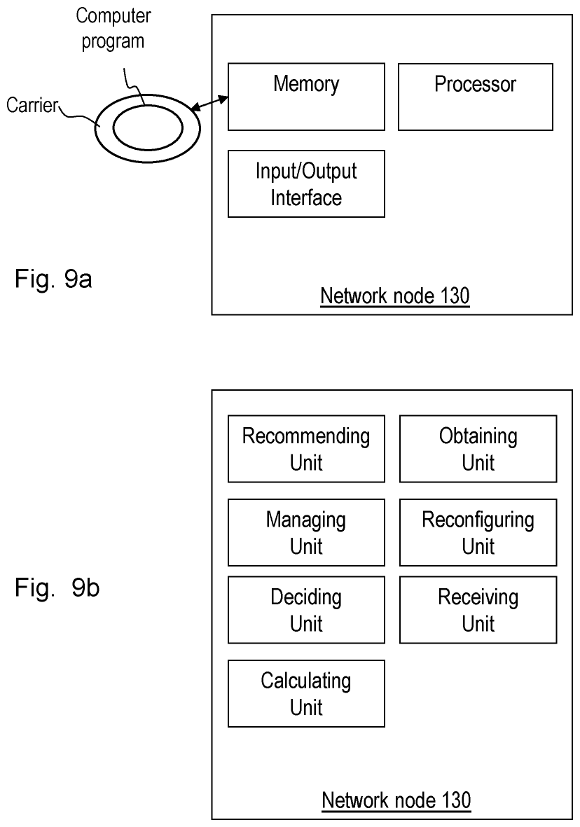

FIGS. 9a and 9b shows an example of arrangement in the network node 130.

The network node 130 may comprise an input and output interface configured to communicate with each other. The input and output interface may comprise a wireless receiver (not shown) and a wireless transmitter (not shown).

The network node 130 may comprise a calculating unit, a receiving unit, a deciding unit, a reconfiguring unit, a managing unit, an obtaining unit, and a recommending unit to perform the method actions as described herein.

The embodiments herein may be implemented through a respective processor or one or more processors, such as the processor of a processing circuitry in the network node 130 depicted in FIG. 9a, together with computer program code for performing the functions and actions of the embodiments herein. The program code mentioned above may also be provided as a computer program product, for instance in the form of a data carrier carrying computer program code for performing the embodiments herein when being loaded into the network node 130. One such carrier may be in the form of a CD ROM disc. It is however feasible with other data carriers such as a memory stick. The computer program code may furthermore be provided as pure program code on a server and downloaded to the network node 130.

The network node 130 may further comprise respective a memory comprising one or more memory units. The memory comprises instructions executable by the processor in the network node 130.

The memory is arranged to be used to store instructions, data, configurations, and applications to perform the methods herein when being executed in the network node 130.

In some embodiments, a computer program comprises instructions, which when executed by the at least one processor, cause the at least one processor of the network node 130 to perform the actions above.

In some embodiments, a respective carrier comprises the respective computer program, wherein the carrier is one of an electronic signal, an optical signal, an electromagnetic signal, a magnetic signal, an electric signal, a radio signal, a microwave signal, or a computer-readable storage medium.

Those skilled in the art will also appreciate that the functional modules in the network node 130, described below may refer to a combination of analog and digital circuits, and/or one or more processors configured with software and/or firmware, e.g. stored in the network node 130, that when executed by the respective one or more processors such as the processors described above cause the respective at least one processor to perform actions according to any of the actions above. One or more of these processors, as well as the other digital hardware, may be included in a single Application-Specific Integrated Circuitry (ASIC), or several processors and various digital hardware may be distributed among several separate components, whether individually packaged or assembled into a system-on-a-chip (SoC).

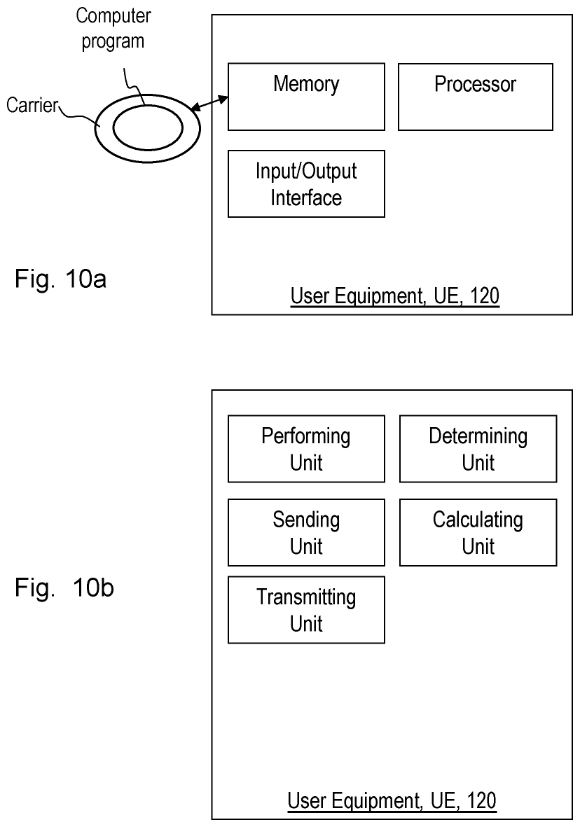

FIGS. 10a and 10b shows an example of arrangements in the UE 120.

The UE 120 may comprise an input and output interface configured to communicate with each other. The input and output interface may comprise a wireless receiver (not shown) and a wireless transmitter (not shown).

The UE 120 may comprise a transmitting unit, a calculating unit, a sending unit, a determining unit, and a performing unit configured to perform the method actions as described herein.

The embodiments herein may be implemented through a respective processor or one or more processors, such as the processor of a processing circuitry in the UE 120 depicted in FIG. 10a, together with respective computer program code for performing the functions and actions of the embodiments herein. The program code mentioned above may also be provided as a computer program product, for instance in the form of a data carrier carrying computer program code for performing the embodiments herein when being loaded into the UE 120. One such carrier may be in the form of a CD ROM disc. It is however feasible with other data carriers such as a memory stick. The computer program code may furthermore be provided as pure program code on a server and downloaded to the UE 120.

The UE 120 may further comprise respective a memory comprising one or more memory units. The memory comprises instructions executable by the processor in the UE 120.

The memory is arranged to be used to store instructions, data, configurations, and applications to perform the methods herein when being executed in the UE 120.

In some embodiments, a computer program comprises instructions, which when executed by the at least one processor, cause the at least one processor of the UE 120 to perform the actions above.

In some embodiments, a respective carrier comprises the respective computer program, wherein the carrier is one of an electronic signal, an optical signal, an electromagnetic signal, a magnetic signal, an electric signal, a radio signal, a microwave signal, or a computer-readable storage medium.

Those skilled in the art will also appreciate that the functional modules in the UE 120, described below may refer to a combination of analog and digital circuits, and/or one or more processors configured with software and/or firmware, e.g. stored in the UE 120, that when executed by the respective one or more processors such as the processors described above cause the respective at least one processor to perform actions according to any of the actions above. One or more of these processors, as well as the other digital hardware, may be included in a single Application-Specific Integrated Circuitry (ASIC), or several processors and various digital hardware may be distributed among several separate components, whether individually packaged or assembled into a system-on-a-chip (SoC).

When using the word “comprise” or “comprising” it shall be interpreted as non-limiting, i.e. meaning “consist at least of”.

The embodiments herein are not limited to the above described preferred embodiments. Various alternatives, modifications and equivalents may be used.

embodiments. Various alternatives, modifications and equivalents may be used.

Below, some example embodiments 1-16 are shortly described. See e.g. FIGS. 5-8a, 8b, 9a, 9b, 10a and 10b.

Embodiment 1. A method performed by a network node 130, e.g. LMF, e.g. for handling positioning of a User Equipment, UE, 120 in a wireless communications network 10, the method comprising any one or more out of:
recommending 601 configurations for multiple Transmission Reception Points, TRPs, 111, 112, 113 to transmit positioning signals e.g. in one or more resources, and
recommending 100, 602 configurations for the UE 120 to perform positioning measurement of the positioning signals transmitted by the multiple TRPs 111, 112, 113,
obtaining 300, 604 a position of the UE 120 based on positioning measurement results of the multiple TRPs 111, 112, 113,
obtaining 300, 605 errors based on uncertainty associated with the positioning measurement results of the multiple TRPs 111, 112, 113,
obtaining 300, 606 a Geometric Dilution of Precision, GDOP, for the multiple TRPs 111, 112, 113 based on the obtained errors and the position of the UE 120,
managing 400, 607 transmission of the positioning signals of the multiple TRPs 111, 112, 113, based on the obtained GDOP.

Embodiment 2. The method according to Embodiment 1, wherein managing 400 the transmission of the positioning signals from the one or more TRPs 111, 112, 113 comprises any one or more out of:
when the obtained GDOP is below a threshold at a certain location, reconfiguring one or more TRPs among the multiple TRPs 111, 112, 113 to stop transmitting positioning signals to e.g. perform positioning signalling overhead reduction by, which one or more TRPs e.g. was contributing to make the obtained GDOP below said threshold or poor GDOP,
deciding whether or not to reconfigure one or more TRPs among the multiple TRPs 111, 112, 113 to transmit positioning signals based on the obtained GDOP.

Embodiment 3. UE based embodiment: The method according to any of the Embodiments 1-2, further comprising:
receiving 200, 603 positioning measurement results of the respective multiple TRPs 111, 112, 113, and information about an uncertainty associated with the respective positioning measurement result and location estimates.

Embodiment 4. UE based embodiment The method according to any of the Embodiments 1-3, wherein any one out of:
obtaining 300, 604 a position of the UE 120 based on the positioning measurement results of the multiple TRPs 111, 112, 113, is performed by calculating the position of the UE 120 based on the positioning measurement results of the multiple TRPs 111, 112, 113, and
obtaining 300, 605 errors based on uncertainty associated with the positioning measurement results of the multiple TRPs 111, 112, 113, is performed by calculating the errors based on uncertainty associated with the positioning measurement results of the multiple TRPs 111, 112, 113,
obtaining 300, 606 a GDOP for the multiple TRPs 111, 112, 113 based on the obtained errors and the position of the UE 120, is performed by calculating 300, 606 a GDOP for the multiple TRPs 111, 112, 113 based on the obtained errors and the position of the UE 120.

Embodiment 5. UE assisted embodiment: The method according to any of the Embodiments 1-3, wherein any one out of:
the position of the UE 120 based on the positioning measurement results of the multiple TRPs 111, 112, 113, is obtained by receiving it from the UE 120, and
the errors based on uncertainty associated with the positioning measurement results of the multiple TRPs 111, 112, 113, is obtained by receiving it from the UE 120,
the GDOP for the multiple TRPs 111, 112, 113 based on the obtained errors and the position of the UE 120, is obtained by receiving it from the UE 120.

Embodiment 6. A computer program comprising instructions, which when executed by a processor, causes the processor to perform actions according to any of the Embodiments 1-5.

Embodiment 7. A carrier comprising the computer program of Embodiment 6, wherein the carrier is one of an electronic signal, an optical signal, an electromagnetic signal, a magnetic signal, an electric signal, a radio signal, a microwave signal, or a computer-readable storage medium.

Embodiment 8. A method performed by a User Equipment, UE, e.g. for handling positioning of the UE 120 in a wireless communications network 10, the method comprising any one or more out of:
performing 100, 703 positioning measurement of positioning signals transmitted by multiple TRPs 111, 112, 113 according to a configuration,
determining 300, 704 information about an uncertainty associated with the respective positioning measurements of the multiple TRPs 111, 112, 113,
wherein any one out of:
i performing:
sending 705 the positioning measurement results and information to a network node 130 to be used for managing transmission of the positioning signals of the multiple TRPs 111, 112, 113,
ii or performing:
calculating 100, 706 a position of the UE 120 based on positioning measurements of the multiple TRPs 111, 112, 113,
calculating 300, 707 errors based on uncertainty associated with the positioning measurements of the multiple TRPs 111, 112, 113, and
calculating 300, 708 a Geometric Dilution of Precision, GDOP, for the multiple TRPs 111, 112, 113 based on the obtained errors and the position of the UE 120,
transmitting 300, 709 the GDOP to the network node 130 to be used for managing transmission of the positioning signals of the multiple TRPs 111, 112, 113.

Embodiment a processor, causes the processor to perform actions according to Embodiment 8.

Embodiment 10. A carrier comprising the computer program of Embodiment 9, wherein the carrier is one of an electronic signal, an optical signal, an electromagnetic signal, a magnetic signal, an electric signal, a radio signal, a microwave signal, or a computer-readable storage medium.

Embodiment 11. A network node 130, e.g. LMF, e.g. configured to handle positioning of a User Equipment, UE, 120 in a wireless communications network 10, wherein the network node 130 further is configured to any one or more out of:
recommend, e.g. by means of a recommending unit, configuration for multiple Transmission Reception Points, TRPs, 111, 112, 113 to transmit positioning signals e.g. in one or more resources, and
recommend, e.g. by means of the recommending unit, configuration for the UE 120 to perform positioning measurement of the positioning signals transmitted by the multiple TRPs 111, 112, 113,
obtain, e.g. by means of an obtaining unit, a position of the UE 120 based on positioning measurement results of the multiple TRPs 111, 112, 113,
obtain, e.g. by means of the obtaining unit, errors based on uncertainty associated with the positioning measurement results of the multiple TRPs 111, 112, 113,
obtain, e.g. by means of the obtaining unit, a Geometric Dilution of Precision, GDOP, for the multiple TRPs 111, 112, 113 based on the obtained errors and the position of the UE 120, and
manage, e.g. by means of a managing unit, transmission of the positioning signals of the multiple TRPs 111, 112, 113, based on the obtained GDOP.

Embodiment 12. The network node 130, according to Embodiment 11, further being configured to:
manage, e.g. by means of the managing unit, the transmission of the positioning signals from the one or more TRPs 111, 112, 113 by any one or more out of:
   reconfiguring, e.g. by means of a reconfiguring unit, one or more TRPs among the multiple TRPs 111, 112, 113 to stop transmitting positioning signals, e.g. to perform positioning signalling overhead reduction, when the obtained GDOP is below a threshold at a certain location, which one or more TRPs e.g. was adapted to contribute to make the obtained GDOP below said threshold or poor GDOP,
   deciding, e.g. by means of a deciding unit, whether or not to reconfigure one or more TRPs among the multiple TRPs 111, 112, 113 to transmit positioning signals based on the obtained GDOP.

Embodiment 13. UE based embodiment: The network node 130, according to any of the Embodiments 11-12, further being configured to:
receive, e.g. by means of receiving unit, positioning measurement results of the respective multiple TRPs 111, 112, 113, and information about an uncertainty associated with the respective positioning measurement result and location estimates.

Embodiment 14. UE based embodiment: The network node 130, according to any of the Embodiments 11-13, further being configured to:
obtain, e.g. by means of the obtaining unit, a position of the UE 120 based on the positioning measurement results of the multiple TRPs 111, 112, 113, by calculating, e.g. by means of a calculating unit, the position of the UE 120 based on the positioning measurement results of the multiple TRPs 111, 112, 113, and
obtain, e.g. by means of the obtaining unit, errors based on uncertainty associated with the positioning measurement results of the multiple TRPs 111, 112, 113, by calculating, e.g. by means of the calculating unit, the errors based on uncertainty associated with the positioning measurement results of the multiple TRPs 111, 112, 113, and
obtain, e.g. by means of the obtaining unit, a GDOP for the multiple TRPs 111, 112, 113 based on the obtained errors and the position of the UE 120, by calculating, e.g. by means of the calculating unit, a GDOP for the multiple TRPs 111, 112, 113 based on the obtained errors and the position of the UE 120.

Embodiment 15. UE assisted embodiment: The network node 130, according to any of the Embodiments 11-14, wherein any one out of:
the position of the UE 120 based on the positioning measurement results of the multiple TRPs 111, 112, 113, is arranged to be obtained, e.g. by means of the obtaining unit, by the network node 130 being configured to receive, e.g. by means of the receiving unit, the position of the UE 120 from the UE 120, and
the errors based on uncertainty associated with the positioning measurement results of the multiple TRPs 111, 112, 113, is arranged to be obtained, e.g. by means of the obtaining unit, by the network node 130 being configured to receive, e.g. by means of the receiving unit, the errors from the UE 120, and
the GDOP for the multiple TRPs 111, 112, 113 based on the obtained errors and the position of the UE 120, is arranged to be obtained, e.g. by means of the obtaining unit, by the network node 130 being configured to receive, e.g. by means of the receiving unit, the GDOP from the UE 120.

Embodiment 16. A User Equipment, UE, e.g. configured to handle positioning of the UE 120 in a wireless communications network 10, wherein the UE 120 further is configured to any one or more out of:
perform, e.g. by means of a performing unit, positioning measurement of positioning signals transmitted by multiple TRP 111, 112, 113 according to a configuration,
determine, e.g. by means of a determining unit, information about an uncertainty associated with the respective positioning measurements of the multiple TRPs 111, 112, 113,
wherein the UE 120 is configured to any one out of i or ii:
i send, e.g. by means of a sending unit, the positioning measurement results and information to a network node 130 to be used for managing transmission of the positioning signals of the multiple TRPs 111, 112, 113, or
ii any one or more of the following:
   calculate, e.g. by means of a calculating unit, a position of the UE 120 based on positioning measurements of the multiple TRPs 111, 112, 113,
   calculate, e.g. by means of the calculating unit, errors based on uncertainty associated with the positioning measurements of the multiple TRPs 111, 112, 113, and
   calculate, e.g. by means of the calculating unit, a Geometric Dilution of Precision, GDOP, for the multiple TRPs 111, 112, 113 based on the obtained errors and the position of the UE 120,
   transmit, e.g. by means of a transmitting unit, the GDOP to the network node 130 to be used for managing transmission of the positioning signals of the multiple TRPs 111, 112, 113.

| Abbreviation | Explanation |
|---|---|
| LOS | Line of Sight |
| MDT | Minimization of Drive Test |
| NLOS | Non-Line of Sight |
| GDOP | Geometric Dilution of Precision |
| RSTD | Relative Signal Time Difference |
| LMF | Location Management Function |
| RRC | Radio Resource Control |
| RRM | Radio Resource Management |
| SNR | Signal to Noise Ratio |
| SSB | Synchronization Signal Block |
| SI | System Information |
| SIB | System Information Broadcast |
| DL-TDOA | Downlink Time difference of Arrival |

### Further Extensions and Variations

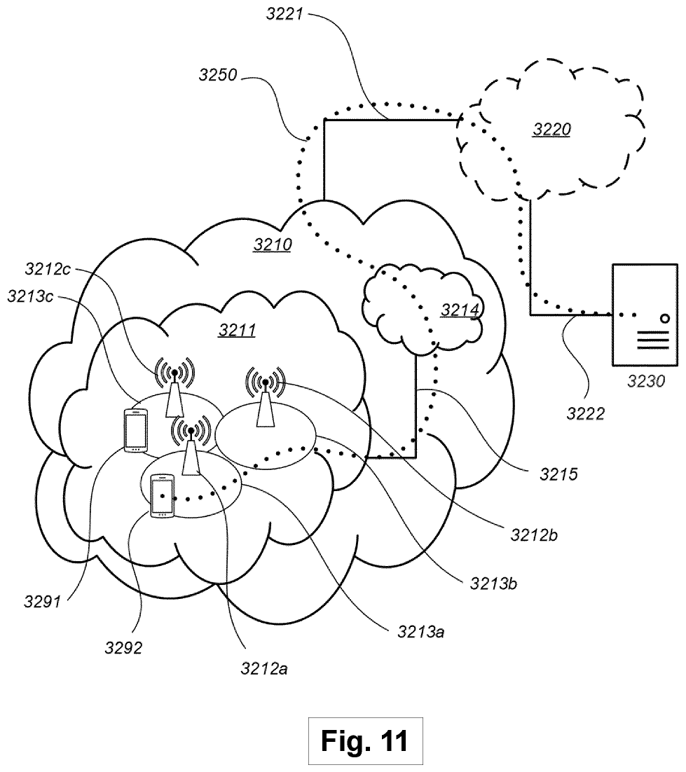

With reference to FIG. 11, in accordance with an embodiment, a communication system includes a telecommunication network 3210 such as the wireless communications network 10, e.g. an IoT network, or a WLAN, such as a 3GPP-type cellular network, which comprises an access network 3211, such as a radio access network, and a core network 3214. The access network 3211 comprises a plurality of base stations 3212a, 3212b, 3212c, such as the network node 130, access nodes, AP STAs NBs, eNBs, gNBs or other types of wireless access points, each defining a corresponding coverage area 3213a, 3213b, 3213c. Each base station 3212a, 3212b, 3212c is connectable to the core network 3214 over a wired or wireless connection 3215. A first user equipment (UE) e.g. the UE 120 such as a Non-AP STA 3291 located in coverage area 3213c is configured to wirelessly connect to, or be paged by, the corresponding base station 3212c. A second UE 3292 e.g. the wireless device 122 such as a Non-AP STA in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

The communication system of FIG. 11 as a whole enables connectivity between one of the connected UEs 3291, 3292 and the host computer 3230. The connectivity may be described as an over-the-top (OTT) connection 3250. The host computer 3230 and the connected UEs 3291, 3292 are configured to communicate data and/or signaling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE 3291 towards the host computer 3230.

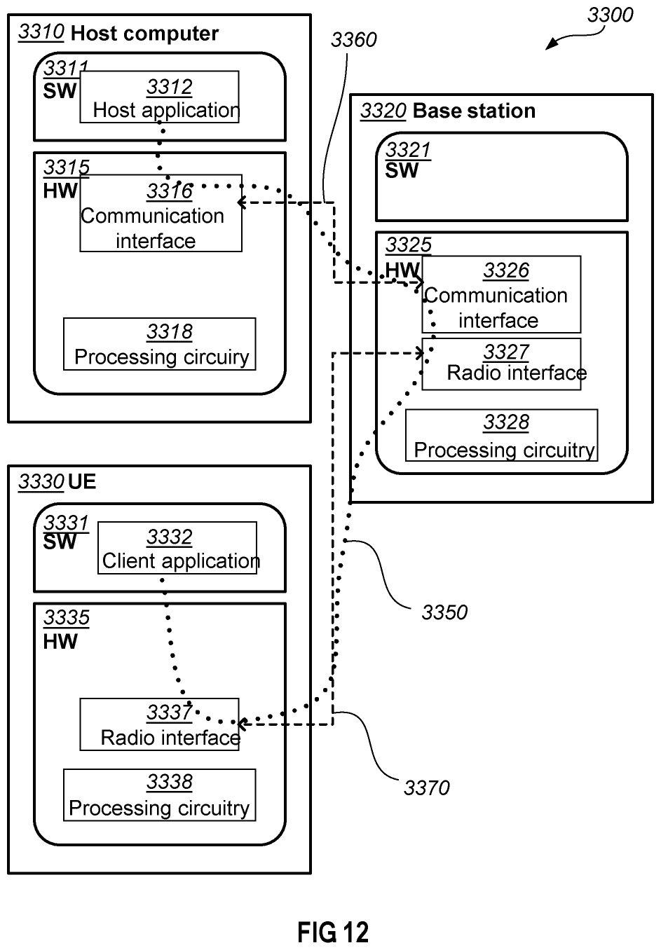

Example implementations, in accordance with an embodiment, of the UE, base station and host computer discussed in the preceding paragraphs will now be described with reference to FIG. 12. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown) served by the base station 3320. The communication interface 3326 may be configured to facilitate a connection 3360 to the host computer 3310. The connection 3360 may be direct or it may pass through a core network (not shown in FIG. 12) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to set up and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides.

It is noted that the host computer 3310, base station 3320 and UE 3330 illustrated in FIG. 12 may be identical to the host computer 3230, one of the base stations 3212a, 3212b, 3212c and one of the UEs 3291, 3292 of FIG. 11, respectively. This is to say, the inner workings of these entities may be as shown in FIG. 12 and independently, the surrounding network topology may be that of FIG. 11.

In FIG. 12, the OTT connection 3350 has been drawn abstractly to illustrate the communication between the host computer 3310 and the use equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing (e.g., on the basis of load balancing consideration or reconfiguration of the network).

The wireless connection 3370 between the UE 3330 and the base station 3320 is in accordance with the teachings of the embodiments described throughout this disclosure. One or more of the various embodiments improve the performance of OTT services provided to the UE 3330 using the OTT connection 3350, in which the wireless connection 3370 forms the last segment. More precisely, the teachings of these embodiments may improve the applicable RAN effect: data rate, latency, power consumption, and thereby provide benefits such as corresponding effect on the OTT service: e.g. reduced user waiting time, relaxed restriction on file size, better responsiveness, extended battery lifetime.

A measurement procedure may be provided for the purpose of monitoring data rate, latency and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signaling facilitating the host computer's 3310 measurements of throughput, propagation times, latency and the like. The measurements may be implemented in that the software 3311, 3331 causes messages to be transmitted, in particular empty or ‘dummy’ messages, using the OTT connection 3350 while it monitors propagation times, errors etc.

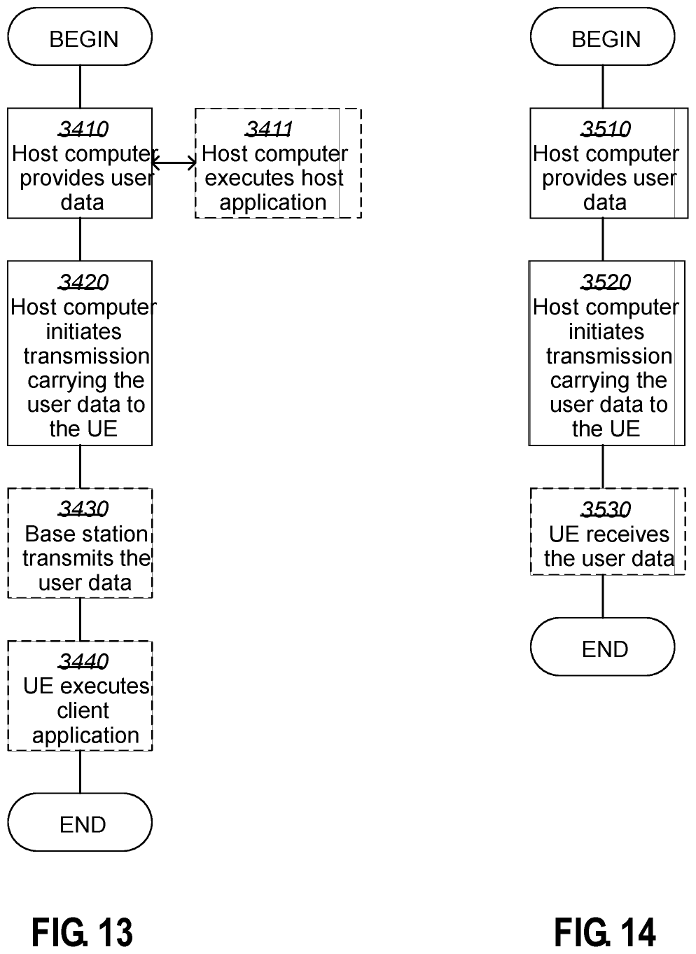

FIG. 13 is a flowchart illustrating a method implemented in a communication system, in accordance with one embodiment. The communication system includes a host computer, a base station such as the network node 110, and a UE such as the UE 120, which may be those described with reference to FIG. 11 and FIG. 12. For simplicity of the present disclosure, only drawing references to FIG. 13 will be included in this section. In a first action 3410 of the method, the host computer provides user data. In an optional subaction 3411 of the first action 3410, the host computer provides the user data by executing a host application. In a second action 3420, the host computer initiates a transmission carrying the user data to the UE. In an optional third action 3430, the base station transmits to the UE the user data which was carried in the transmission that the host computer initiated, in accordance with the teachings of the embodiments described throughout this disclosure. In an optional fourth action 3440, the UE executes a client application associated with the host application executed by the host computer.

FIG. 14 is a flowchart illustrating a method implemented in a communication system, in accordance with one embodiment. The communication system includes a host computer, a base station such as a AP STA, and a UE such as a Non-AP STA which may be those described with reference to FIG. 11 and FIG. 12. For simplicity of the present disclosure, only drawing references to FIG. 14 will be included in this section. In a first action 3510 of the method, the host computer provides user data. In an optional subaction (not shown) the host computer provides the user data by executing a host application. In a second action 3520, the host computer initiates a transmission carrying the user data to the UE. The transmission may pass via the base station, in accordance with the teachings of the embodiments described throughout this disclosure. In an optional third action 3530, the UE receives the user data carried in the transmission.

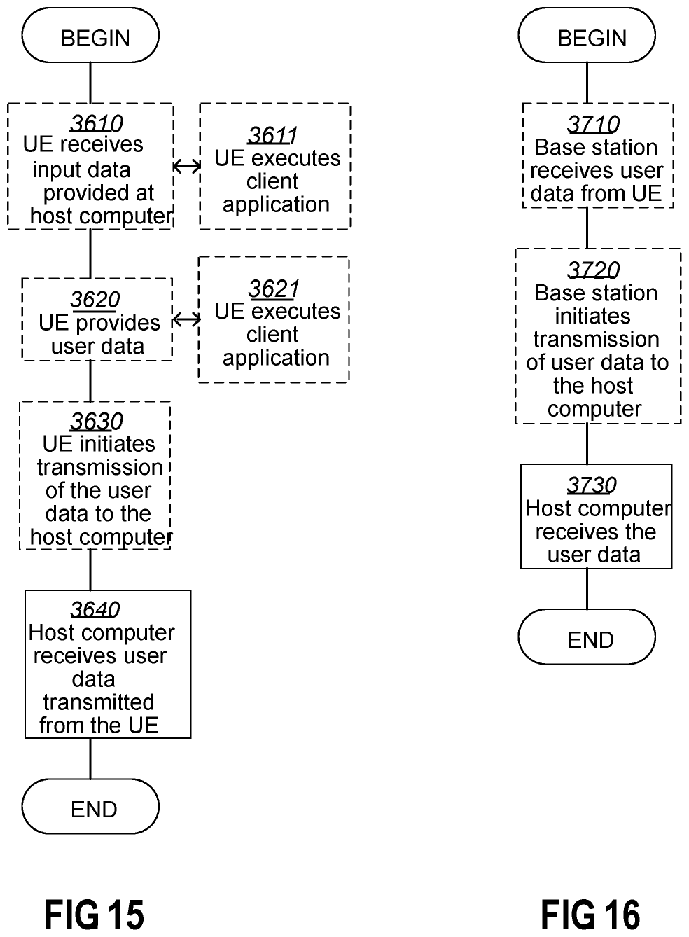

FIG. 15 is a flowchart illustrating a method implemented in a communication system, in accordance with one embodiment. The communication system includes a host computer, a base station such as a AP STA, and a UE such as a Non-AP STA which may be those described with reference to FIG. 11 and FIG. 12. For simplicity of the present disclosure, only drawing references to FIG. 15 will be included in this section. In an optional first action 3610 of the method, the UE receives input data provided by the host computer. Additionally or alternatively, in an optional second action 3620, the UE provides user data. In an optional subaction 3621 of the second action 3620, the UE provides the user data by executing a client application. In a further optional subaction 3611 of the first action 3610, the UE executes a client application which provides the user data in reaction to the received input data provided by the host computer. In providing the user data, the executed client application may further consider user input received from the user. Regardless of the specific manner in which the user data was provided, the UE initiates, in an optional third subaction 3630, transmission of the user data to the host computer. In a fourth action 3640 of the method, the host computer receives the user data transmitted from the UE, in accordance with the teachings of the embodiments described throughout this disclosure.

FIG. 16 is a flowchart illustrating a method implemented in a communication system, in accordance with one embodiment. The communication system includes a host computer, a base station such as a AP STA, and a UE such as a Non-AP STA which may be those described with reference to FIG. 11 and FIG. 12. For simplicity of the present disclosure, only drawing references to FIG. 16 will be included in this section. In an optional first action 3710 of the method, in accordance with the teachings of the embodiments described throughout this disclosure, the base station receives user data from the UE. In an optional second action 3720, the base station initiates transmission of the received user data to the host computer. In a third action 3730, the host computer receives the user data carried in the transmission initiated by the base station.

The following may be reflected according to and implemented in embodiments herein:
Small data Transmission (SDT), UL Positioning and On Demand PRS Aspects
SDT Framework for Positioning

There may be several concerns of using a SDT framework. The concerns are listed below:
Lack of SDT Support for Control Plane Solution

The scope of Rel-17 WI for SDT does not include CP Solution. Only UP Solution is in the scope. LPP is transported over NAS and hence CP based signalling is required. In such case, it is not possible to use the SDT framework.
Lack of Integrity Protection Support in EDT Control Plane Solution

In LTE, CP Solution for early data transmission do not provide Integrity protection. Only for UP solution it is possible. Positioning measurement report is sensitive information where without IP it should not be delivered. Integrity Protection is a means to allow the receiver to ensure that the sender is indeed who the receiver thinks the sender is. For example, to avoid that another entity has inserted packets in the data flow. RAN2 would have to consult SA3 and solution with IP should be provided for CP solution to deliver sensitive information.

For NB-IoT Rel-16 SON/ANR feature, RAN2 agreed not to support ANR reporting for CP solution because of lack of IP solution [ ].
SDT (Small Data) Positioning (Large Data) SDT framework is for providing data which is meant to be small. Positioning measurements results would not be categorized as small data. For example; below structure considering only 3 TRPs in different cells, including additional path would be more than 1000 bits.

-- ASN1START
NR-DL-TDOA-SignalMeasurementInformation-r16 ::= SEQUENCE {

| | |
|---|---|
| dl-PRS-ReferenceInfo-r16 | DL-PRS-ID-Info-r16, |
| nr-DL-TDOA-MeasList-r16 | NR-DL-TDOA-MeasList-r16, |

...
}
NR-DL-TDOA-MeasList-r16 ::= SEQUENCE (SIZE(1..nrMaxTRPs-r16)) OF NR-DL-TDOA-MeasElement-r16
NR-DL-TDOA-MeasElement-r16 ::= SEQUENCE {

| dl-PRS-ID-r16 | INTEGER (0..255), | |
|---|---|---|
| nr-PhysCellID-r16 | NR-PhysCellID-r16 | OPTIONAL, |
| nr-CellGlobalID-r16 | NCGI-r15 | OPTIONAL, |
| nr-ARFCN-r16 | ARFCN-ValueNR-r15 | OPTIONAL, |
| nr-DL-PRS-ResourceID-r16 | NR-DL-PRS-ResourceID-r16 | OPTIONAL, |
| nr-DL-PRS-ResourceSetID-r16 | NR-DL-PRS-ResourceSetID-r16 | OPTIONAL, |

| | |
|---|---|
| nr-TimeStamp-r16 | NR-TimeStamp-r16, |
| nr-RSTD-r16 | CHOICE { |
| k0-r16 | INTEGER (0..1970049), |
| k1-r16 | INTEGER (0..985025), |
| k2-r16 | INTEGER (0..492513), |
| k3-r16 | INTEGER (0..246257), |
| k4-r16 | INTEGER (0..123129), |
| k5-r16 | INTEGER (0..61565), |

```
    ...
  },
```

| nr-AdditionalPathList-r16 | NR-AdditionalPathList-r16 | OPTIONAL, |
|---|---|---|
| nr-TimingQuality-r16 | NR-TimingQuality-r16, | |
| nr-DL-PRS-RSRP-Result-r16 | INTEGER (0..126) | OPTIONAL, |

nr-DL-TDOA-AdditionalMeasurements-r16

| | |
|---|---|
| NR-DL-TDOA-AdditionalMeasurements-r16 | OPTIONAL, |

...
}
NR-DL-TDOA-AdditionalMeasurements-r16 ::= SEQUENCE (SIZE (1..3)) OF

NR-DL-TDOA-AdditionalMeasurementElement-r16

NR-DL-TDOA-AdditionalMeasurementElement-r16 ::= SEQUENCE {

| | | |
|---|---|---|
| nr-DL-PRS-ResourceID-r16 | NR-DL-PRS-ResourceID-r16 | OPTIONAL, |
| nr-DL-PRS-ResourceSetID-r16 | NR-DL-PRS-ResourceSetID-r16 | OPTIONAL, |

| | |
|---|---|
| nr-TimeStamp-r16 | NR-TimeStamp-r16, |
| nr-RSTD-ResultDiff-r16 | CHOICE { |
| k0-r16 | INTEGER (0..8191), |
| k1-r16 | INTEGER (0..4095), |
| k2-r16 | INTEGER (0..2047), |
| k3-r16 \| | INTEGER (0..1023), |
| k4-r16 | INTEGER (0..511), |
| k5-r16 | INTEGER (0..255), |

```
    ...
  },
```

| nr-TimingQuality-r16 | NR-TimingQuality-r16, | |
|---|---|---|
| nr-DL-PRS-RSRP-ResultDiff-r16 | INTEGER (0..61) | OPTIONAL, |
| nr-AdditionalPathList-r16 | NR-AdditionalPathList-r16 | OPTIONAL, |

...
}
-- ASN1STOP

In LTE, for early EDT, only data less than 1000 bits is delivered using SDT else connected mode procedure is used.

### Architecture Discussion

If using SDT framework, alternate would be to use UP SDT framework. As the data is already available in UPF; UPF may deliver it to LMF. However, this would require a significant change in architecture and SA2 needs to study this option.

Observation 1 There are several issues for SDT CP solution. Lack of CP solution, Integrity protection, measurement report size for positioning to fit in SDT. Further alternate to CP SDT framework; i.e using UP SDT should be studied by SA2.

Proposal 1 RAN2 to agree that SDT Framework using CP solution cannot be used for Positioning.

### UL Positioning

RSTD measurements have been defined for Idle mode in LTE for NB-IoT UEs. This is mainly for power saving purposes. It needs to be discussed whether there is benefit of supporting RSTD measurements in idle mode for NR where the use case is not to serve power limited devices. However, there are benefits that UE which are able to perform positioning using UE based can compute location without LPP transaction; i.e If the AD is being provided by means of broadcast, then UE can use the AD to identify the PRS and perform the measurements inactive mode.

However, in order to wider support; also, to support UE-Assisted case; it should also be studied as how UE would report it's RSTD measurements to NW. As such MO-LR procedure should be used for this.

Observation 2 There may be benefit by defining RSTD measurements inactive mode. RAN1 should define such measurements and RAN2 should further study and consult with SA2 on measurement reporting from UE for the measurements performed inactive mode.

Observation 3 Efficient Positioning measurement reporting from inactive and triggering of inactive to connected mode based on positioning measurement config events would need to be explored further.

Proposal 2 according to some embodiments herein: DL PRS RSTD measurements is supported inactive mode.

However, when it comes to UL-SRS, it would be very complex for the UE to transmit UL SRS in idle/inactive. It would be only useful if the UE is semi-stationary or stationary such that it is always served by same cell and in the same radio condition.

As UL-SRS resource require UL cell specific resource (time/freq) and is allocated to a UE; if UE moves out of the serving cell; gNB should be aware so that the resource would be released. Positioning use case as such involves moving UE, hence UL SRS may not be dynamically allocated/released based upon UE movement. There would be lag with UE context fetch procedure and in the mean while UE may cause interference. For this reason, UL-SRS should not be considered for idle/inactive mode positioning.

Observation 4 UL SRS based inactive positioning may only work for short time after UE is released; i.e if the condition remains same. Positioning involves UE on move and hence it would be difficult to provide efficient signalling (pre-configuration before release) to allow UE to continue transmitting SRS inactive mode.

Proposal 3 UL based Inactive Positioning is not supported.

### On Demand PRS

### GDOP Report

The analysis and result showing how geometry plays important role in positioning performance is provided. The Geometric dilution of Precision (GDOP) is an important attribute that can influence the accuracy of location in positioning methods which use multilateration. It describes error caused by the relative position of the base stations, cells or beams etc. If the base stations (beams/cells) location are too close to each other and not well spread around the UE, the reported RSTD value would suffer from poor GDOP resulting in location estimation with large error. However, if they have certain distance/angular separation between them it can result in good GDOP (multilateration) which can identify the UE location more precisely. In a simple form GDOP can be computed as a ratio of position error to the range error.

Based upon GDOP result and analysis, LMF may decide how whether certain TRPs are contributing to positioning performance or not. Hence, this result can help LMF to filter TRPs for PRS transmission.

For UE based, UE computes the position and positioning error and hence GDOP information is available to UE. UE should share such info to LMF to facilitate in PRS overhead reduction.

Proposal 4 according to embodiments herein: GDOP result is provided to the network node 130 such as e.g. an LMF, by a UE such as the UE 120, operating in UE based mode.

UE Based Authorization while in Broadcast Mode

Currently the network node 130 such as e.g. an LMF provides the authorization whether a UE, such as the UE 120, should operate in UE Assisted (UE-A) or UE Based (UE-B) mode. This sort of authorization may be possible also when AD is being delivered using broadcast. It should be deployment preference to allow UE to operate in certain positioning modes. Depending upon
the need to actively obtain the measurement results in order to tune the network resource suitable for the UE based beam transmission.
to be able to save energy (turn off DL PRS beams that are in NLOS or not contributing to positioning measurements)
Number of UEs, UE distribution in a local geographical area. For example, if there are few UEs in a cell, the DL-PRS beams may be more aligned for these UEs; i.e. there may be no need to have a complete beam coverage (360 degrees) all the time. The number of neighbour beams may also be minimized.

A network node such as a Network (NW) may authorize that a UE, such as the UE 120, in certain geographical area (group of cells) to operate in one of the modes; UE-A or UE-B mode. If NW sets UE-A mode, then the UE-B capable UEs may still compute and consume the positioning while providing the measurement results to the NW for PRS overhead management purpose.

Proposal 5 according to embodiments herein: Allow a deployment to specify which positioning mode the UE, such as the UE 120, may operate in via broadcast.

### CONCLUSION

In the previous sections the following observations has been made:

Observation 1 There are several issues for SDT CP solution. Lack of CP solution, Integrity protection, measurement report size for positioning to fit in SDT. Further alternate to CP SDT framework; i.e using UP SDT should be studied by SA2.

Observation 2 There may be benefit by defining RSTD measurements inactive mode. RAN1 should define such measurements and RAN2 should further study and consult with SA2 on measurement reporting from UE for the measurements performed inactive mode.

Observation 3 Efficient Positioning measurement reporting from inactive and triggering of inactive to connected mode based on positioning measurement config events would need to be explored further.

Observation 4 UL SRS based inactive positioning may only work for short time after UE is released; i.e. if the condition remains same. Positioning involves UE on move and hence it would be difficult to provide efficient signalling (pre-configuration before release) to allow UE to continue transmitting SRS inactive mode.

Based on the discussion in the previous sections we propose the following:

Proposal 1 RAN2 to agree that SDT Framework using CP solution cannot be used for Positioning.

Proposal 2 according to embodiments herein DL PRS RSTD measurements is supported inactive mode.

Proposal 3 UL based Inactive Positioning is not supported.

Proposal 4 according to embodiments herein GDOP result is provided to the network node 130 such as e.g. an LMF by UE, such as the UE 120, operating in UE based mode.

Proposal 5 according to embodiments herein: Allow a deployment to specify which positioning mode the UE, such as the UE 120, may operate in via broadcast.

1.-29. (canceled)

30. A method performed by a network node for handling positioning of a User Equipment (UE) in a wireless communications network, the method comprising:
recommending configurations for multiple Transmission Reception Points (TRPs) to transmit positioning signals;
recommending a configuration for the UE to perform respective positioning measurements of the positioning signals transmitted by the multiple TRPs;
obtaining a position of the UE based on results of the respective positioning measurements;
obtaining errors based on uncertainty associated with the results of the respective positioning measurement results;
obtaining a Geometric Dilution of Precision (GDOP) for the multiple TRPs based on the obtained errors and the position of the UE; and
managing transmission of the positioning signals of the multiple TRPs, based on the obtained GDOP.

31. The method according to claim 30, wherein obtaining the GDOP for the multiple TRPs further comprises:
obtaining the GDOP from the UE as logged by the UE;
obtaining a report of whether the GDOP is based upon assistance data received in broadcast; and/or
obtaining a cell Identity (ID) list of corresponding TRPs that were used for the GDOP.

32. The method according to claim 30, wherein obtaining the GDOP for the multiple TRPs comprises obtaining the GDOP as provided as part of a Minimization of Drive Test (MDT) and/or Self-Organizing Networks (SON) logged result.

33. The method according to claim 30, wherein obtaining the GDOP further comprises receiving a sorted TRP list based upon the GDOP for the multiple TRPs comprising a respective rating category according to any one out of: Poor, Fair, Moderate, Good, Excellent, Excellent, Ideal, or No measurement.

34. The method according to claim 30, wherein the configuration for the UE to perform respective positioning measurements of the positioning signals transmitted by the multiple TRPs further comprises a configuration to log GDOP results.

35. The method according to claim 30, wherein managing the transmission of the positioning signals from the TRPs comprises any one or more out of:
when the obtained GDOP is below a threshold at a certain location, reconfiguring one or more TRPs among the multiple TRPs to stop transmitting positioning signals, which one or more TRPs were contributing to make the obtained GDOP below said threshold; or
deciding whether or not to reconfigure one or more TRPs among the multiple TRPs to transmit positioning signals based on the obtained GDOP.

36. The method according to claim 30, further comprising receiving the results of the respective positioning measurement and information about the uncertainty associated with the results of the respective positioning measurement result and location estimates.

37. The method according to claim 30, wherein any one out of:
obtaining the position of the UE is performed by calculating the position of the UE based on the results of the respective positioning measurements;
obtaining the errors is performed by calculating the errors based on uncertainty associated with the results of the respective positioning measurements; or
obtaining the GDOP is performed by calculating the GDOP for the multiple TRPs based on the obtained errors and the position of the UE.

38. The method according to claim 30, wherein any one out of:
the position of the UE is obtained by receiving the position from the UE;
the errors are obtained by receiving the errors from the UE; or
the GDOP is obtained by receiving the GDOP from the UE.

39. A method performed by a User Equipment (UE) for handling positioning of the UE in a wireless communications network, the method comprising:
performing respective positioning measurements of positioning signals transmitted by multiple TRPs according to a configuration;
determining information about an uncertainty associated with the respective positioning measurements of the multiple TRPs;
calculating a position of the UE based on results of the respective positioning measurements;
calculating errors based on uncertainty associated with the results of the respective positioning measurements;
calculating a Geometric Dilution of Precision (GDOP) for the multiple TRPs based on the obtained errors and the position of the UE; and
transmitting the GDOP to a network node to be used for managing transmission of the positioning signals of the multiple TRPs.

40. The method according to claim 39, wherein the calculating of the GDOP further comprises logging the GDOP, wherein logging the GDOP comprises any one or more out of:
logging the GDOP and identifying a group of multiple TRPs based upon the GDOP, to provide high quality location accuracy; and
logging the GDOP and identifying a group of TRPs based upon the GDOP to provide low quality location accuracy.

41. The method according to claim 39, wherein transmitting the GDOP to the network node further comprises transmitting a report of whether the GDOP is based upon assistance data received in broadcast.

42. The method according to claim 39, wherein the transmitting the GDOP to the network node further comprises transmitting a cell Identity (ID) list of corresponding TRPs that was used for the GDOP.

43. The method according to claim 39, wherein the GDOP is transmitted to the network node as part of a Minimization of Drive Test (MDT) and/or Self-Organizing Networks (SON) logged result.

44. A network node configured to handle positioning of a User Equipment (UE) in a wireless communications network, wherein the network node comprises processing circuitry configured to:
recommend configurations for multiple Transmission Reception Points (TRPs) to transmit positioning signals;
recommend a configuration for the UE to perform respective positioning measurements of the positioning signals transmitted by the multiple TRPs;
obtain a position of the UE based on results of the respective positioning measurements;
obtain errors based on uncertainty associated with the results of the respective positioning measurement results;
obtain a Geometric Dilution of Precision (GDOP) for the multiple TRPs based on the obtained errors and the position of the UE; and
manage transmission of the positioning signals of the multiple TRPs, based on the obtained GDOP.

45. The network node according to claim 44, the processing circuitry further being configured to manage the transmission of the positioning signals from one or more TRPs by any one or more out of:
reconfiguring one or more TRPs among the multiple TRPs to stop transmitting positioning signals, when the obtained GDOP is below a threshold at a certain location, which one or more TRPs contribute to making the obtained GDOP below said threshold; or
deciding whether or not to reconfigure one or more TRPs among the multiple TRPs to transmit positioning signals based on the obtained GDOP.

46. The network node according to claim 44, the processing circuitry further being configured to receive results of the respective positioning measurement and information about an uncertainty associated with the respective positioning measurements and location estimates.

47. The network node according to claim 44, the processing circuitry being configured to:
obtain the position of the UE by calculating the position of the UE based on the results of the respective positioning measurement;
obtain the errors by calculating the errors based on uncertainty associated with the results of the respective positioning measurements; or
obtain the GDOP by calculating the GDOP based on the obtained errors and the position of the UE.

48. The network node according to claim 44, the processing circuitry being configured to:
obtain the position of the UE by receiving the position of the UE from the UE;
obtain the errors by receiving the errors from the UE; or
obtain the GDOP by receiving the GDOP from the UE.

49. A User Equipment (UE) configured to handle positioning of the UE in a wireless communications network, wherein the UE comprises processing circuitry configured to:
perform respective positioning measurements of positioning signals transmitted by multiple TRPs according to a configuration;
determine information about an uncertainty associated with the respective positioning measurements of the multiple TRPs;
calculate a position of the UE based on results of the respective positioning measurements;
calculate errors based on uncertainty associated with the results of the respective positioning measurements;
calculate a Geometric Dilution of Precision (GDOP) for the multiple TRPs based on the obtained errors and the position of the UE; and
transmit the GDOP to a network node to be used for managing transmission of the positioning signals of the multiple TRPs.
